(19) United States
(12) Patent Application Publication
(10) Pub. No.: US 2024/0061871 A1
(43) Pub. Date: Feb. 22, 2024

(54) SYSTEMS AND METHODS FOR AD HOC ANALYSIS OF TEXT OF DATA RECORDS

(71) Applicant: SparkCognition, Inc., Austin, TX (US)

(72) Inventors: Jaidev Amrite, Austin, TX (US); Francisco Ibanez Castillo, Austin, TX (US); Abhijit Rao, Leander, TX (US)

(21) Appl. No.: 18/366,242

(22) Filed: Aug. 7, 2023

Related U.S. Application Data
(60) Provisional application No. 63/373,134, filed on Aug. 22, 2022.

(51) Int. Cl. G06F 16/332; G06F 40/30; G06F 16/35; G06F 16/383

(52) U.S. Cl. CPC G06F 16/3328; G06F 40/30; G06F 16/35; G06F 16/383

(57) ABSTRACT

A method includes receiving, at one or more processors, input indicating selection of a data field of a plurality of data records. The method also includes, responsive to the selection, performing, by the one or more processors, a clustering operation to generate clusters based on semantic similarity of text content of the data field in the plurality of data records. The method further includes filtering, by the one or more processors, the plurality of data records based on the clusters to generate filtered data records and generating output representing the filtered data records.

### CROSS-REFERENCE TO RELATED APPLICATION

The present application claims priority from U.S. Provisional Patent Application No. 63/373,134 filed Aug. 22, 2022, the content of which is incorporated by reference herein in its entirety.

### BACKGROUND

Many record keeping systems retain large quantities of information in unstructured data fields, such as natural language text fields, or in both structured and unstructured data fields. For large record keeping systems (e.g., enterprise level systems), it is common for multiple users to input data into such systems, which can lead to the use of different nomenclature to describe similar or related concepts. As a result, while a record keeping system may contain a large amount of information, it can be difficult to extract the information to identify relevant content or trends.

As one example, a work order management system, such as may be used for managing information technology (IT) or facility management work orders via a work order ticketing system, can be helpful to track problems and the corrective actions used to resolve them. Such systems typically receive an input notification (e.g., ticket creation) that indicates some type of problem that needs corrective action. The systems may also store information related to the cause of the problem, troubleshooting steps used to identify the cause of the problem, and/or actions that were taken to resolve the problem. Different types of information (e.g., problem report, detailed problem description, troubleshooting, problem resolution, etc.) may be described in whole or in part in natural language text data fields. Further, in many situations, an end user reports a problem (e.g., creates a ticket) to initiate a particular data record, and one or more technicians subsequently modify the particular data record to provide information related to resolving the problem. In this situation, it can be difficult to analyze the data records of the work order management system to identify trends (e.g., a change in the frequency of particular types of problems) or commonalities (e.g., actions that resolved similar problems in the past) because of the different terminology and descriptions used in the natural language text of the data records.

In some circumstances, a data scientist or engineer may be employed to manually analyze data to determine systemic problems, but this can be time consuming and expensive, and there is no way of knowing in advance whether any useful information will result. Additionally, as new information is added to a system or the previous information ages, any analysis manually generated by the data scientist or engineer can become inaccurate or out of date and cease to be helpful, which may entail hiring the data scientist again to update or entirely rework the analysis.

### SUMMARY

Particular implementations of systems and methods to facilitate analysis of records are described herein. Particular systems and methods disclosed herein use machine learning techniques to facilitate analysis of large collections of data records, such as data records of a work order management system, where relevant content of many of the data records is contained in one or more unstructured data fields, such as natural language text fields.

In a particular aspect, a method includes receiving, at one or more processors, input indicating selection of a data field of a plurality of data records. The method also includes, responsive to the selection, performing, by the one or more processors, a clustering operation to generate clusters based on semantic similarity of text content of the data field in the plurality of data records. The method further includes filtering, by the one or more processors, the plurality of data records based on the clusters to generate filtered data records and generating output representing the filtered data records.

In another particular aspect, a device includes one or more memory devices storing instructions and one or more processors configured to execute the instructions to receive input indicating selection of a data field of a plurality of data records, and responsive to the selection, perform a clustering operation to generate clusters based on semantic similarity of text content of the data field in the plurality of data records. The processor(s) are further configured to execute the instructions to filter the plurality of data records based on the clusters to generate filtered data records and generate output representing the filtered data records.

In another particular aspect, a computer readable storage device stores instructions that are executable by one or more processors to perform operations including receiving input indicating selection of a data field of a plurality of data records, and responsive to the selection, performing a clustering operation to generate clusters based on semantic similarity of text content of the data field in the plurality of data records. The operations further include filtering the plurality of data records based on the clusters to generate filtered data records and generating output representing the filtered data records.

### BRIEF DESCRIPTION OF THE DRAWINGS

FIG. 1 is a block diagram of an example of a system configured to perform operations associated with ad hoc analysis of data records that include textual content;

FIG. 2 is a block diagram that illustrates further detail of aspects of a particular implementation of the system of FIG. 1;

FIG. 3 is a block diagram that illustrates further detail of aspects of a particular implementation of the system of FIG. 1;

FIG. 4 is a block diagram that illustrates further detail of aspects of a particular implementation of the system of FIG. 1;

FIG. 5 is a diagram illustrating an example of a graphical user interface that may be generated by the system of FIG. 1 in particular implementations;

FIG. 6 is a diagram illustrating an example of a graphical user interface that may be generated by the system of FIG. 1 in particular implementations;

FIG. 7 is a diagram illustrating an example of a graphical user interface that may be generated by the system of FIG. 1 in particular implementations

FIG. 8 is a diagram illustrating an example of a graphical user interface that may be generated by the system of FIG. 1 in particular implementations

FIG. 9 is a flow chart of an example of a method of ad hoc analysis of data records that include textual content;

FIG. 10 is a flow chart of another example of a method of ad hoc analysis of data records that include textual content;

FIG. 11 is a flow chart of another example of a method of ad hoc analysis of data records that include textual content; and

FIG. 12 is a block diagram of an example of a system that is configured to perform operations associated with ad hoc analysis of data records that include textual content.

### DETAILED DESCRIPTION

According to particular aspects, systems and methods of data analysis are disclosed. In particular, the systems and methods disclosed herein facilitate ad hoc analysis of data records that include data fields storing text (e.g., natural language text). In this context, “ad hoc” refers to user driven analysis, such as filtering data in real-time in response to a user query or other input.

Although aspects of the analysis may be performed in real-time, other aspects may be performed offline or independent of analysis input from a user. For example, to facilitate analysis of semantic content of one or more data fields that include text, the text of such fields may be subjected to embedding operations in order to represent the text of the data field(s) (or of an entire data record) as an embedding vector (also referred to herein as an “embedding”). The terms “embedding” and “embedding vector” are used herein in accordance with their usual and customary meaning within the machine-learning arts and refer to an array or vector of values (e.g., floating point values) that represent semantic content of text as a point in a high-dimensional embedding space. The embedding space may be specific to a particular technical domain (e.g., a medical domain or a particular engineering domain). Alternatively, the embedding space may be directed to a particular language or even to multiple languages. Although embedding of text may be performed in real time (e.g., on an ad hoc basis), computing resources may be conserved by performing embedding operations offline from analysis. For example, an embedding representing a text-based data field of a particular data record may be generated when a user commits the data record (e.g., upon data entry rather than subsequent data analysis). As another example, embedding operations may be performed periodically or occasionally for a set of data records. To illustrate, in a particular implementation, embedding operations may be performed daily or weekly (or on some other schedule) to generate embeddings for all data records that have been updated since the last time embedding operations were performed. In such implementations, the embeddings may be stored (e.g., with the data records) to facilitate later analysis (e.g., on an ad hoc basis).

In a particular aspect, ad hoc data analysis includes clustering responsive to user selection of one or more data fields. For example, a user performing data analysis to check for trends in reported problems may select a “problem report” data field to initiate clustering operations based on embeddings representing text content of the “problem report” data field of a set of data records. In this example, the user may provide additional input to restrict the data records used for the clustering operations. For example, the user may provide input to select only problem reports generated during a particular time period or for a specific piece of equipment. Each cluster generated by the clustering operations represents a group of data records that include semantically similar textual content in the selected data field(s).

In a particular aspect, the clusters can be used to filter data records that are presented to the user. For example, the user can select a particular one of the clusters to see data records that are associated with the particular cluster. The clusters may also be used to perform further analysis. To illustrate, the user may select a particular cluster to be divided into subclusters based on another data field. For example, after generating a first set of clusters based on a “problem report” data field, the user can select a first cluster from among the first set of clusters and initiate a clustering operation to generate a second set of clusters based on a “remarks” data field. In this example, the first cluster of the first set of clusters includes a set of data records from among an entire data management system that include semantically similar text in the “problem report” data field, and each cluster of the second set of clusters includes a set of data records from among data records associated with the first cluster that include semantically similar text in the “remarks” data field. The data records subjected to the clustering operations may also be constrained based on other types of data fields, such as structured data fields (e.g., fields storing logical data or other structured data).

In a particular aspect, the clusters can be used to facilitate generation of a record classifier (e.g., a machine-learning classifier). The record classifier can subsequently be used to apply user-defined category labels to records of the record management system. The category labels can be used to further facilitate data analysis. For example, the category labels assigned by the classifier enable the unstructured data fields to be represented in a common nomenclature in order to simplify manipulation of data records based on semantic content of text of particular data fields. The classifier can be updated or replaced periodically or occasionally using the same or similar machine learning techniques as were used to train the classifier initially. To illustrate, if a user identifies a new category associated with a cluster, a new classifier can be trained to recognize the new category using labeled training data that includes instances of the new category. Thus, the cost and expense associated with manual analysis of the data records (e.g., by a data scientist) is reduced both initially and overtime as new data records are added.

Particular aspects of the present disclosure are described below with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” indicates an example, an implementation, and/or an aspect, and should not be construed as limiting or as indicating a preference or a preferred implementation.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

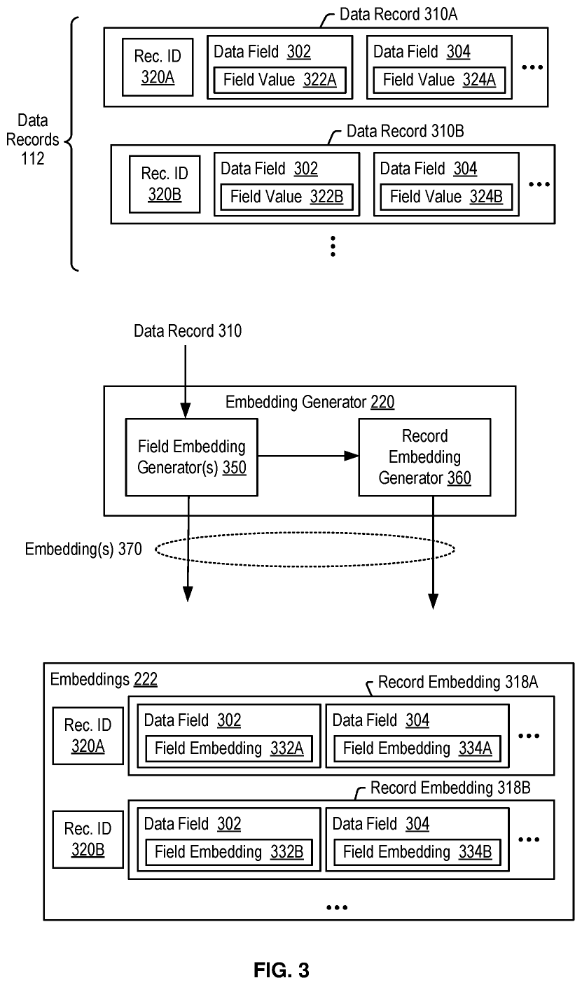

In some drawings, multiple instances of a particular type of feature are used. Although these features may be physically and/or logically distinct, the same reference number is used for each, and the different instances are distinguished by addition of a letter to the reference number. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter. For example, referring to FIG. 3, multiple record embeddings are illustrated and associated with reference numbers 318A and 318B. When referring to a particular record embedding 318, such as the record embedding 318A the distinguishing letter “A” is used. However, when referring to any arbitrary record embedding or the record embeddings as a group, the reference number 318 is used without a distinguishing letter.

As used herein, an ordinal term (e.g., “first,” “second,” “third,” “Nth,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements. Additionally, in some instances, an ordinal term herein may use a letter (e.g., “Nth”) to indicate an arbitrary or open-ended number of distinct elements (e.g., zero or more elements). Different letters (e.g., “N” and “M”) may be used for ordinal terms that describe two or more different elements when no particular relationship among the number of each of the two or more different elements is specified. For example, unless defined otherwise in the text, N may be equal to M, N may be greater than M, or N may be less than M.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

As used herein, the term “machine learning” should be understood to have any of its usual and customary meanings within the fields of computer science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows—a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so-called “transfer learning.” As described further below, in transfer learning a base model may be trained using a generic or typical data set, and the base model may be subsequently refined (e.g., re-trained or further trained) using a more specific data set.

A data set used during training is referred to as a “training data set” or simply “training data.” The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Machine-learning models can be initialized from scratch (e.g., by a user, such as a data scientist) or using a guided process (e.g., using a template or previously built model). Initializing the model includes specifying parameters and hyperparameters of the model. “Hyperparameters” are characteristics of a model that are not modified during training, and “parameters” of the model are characteristics of the model that are modified during training. The term “hyperparameters” may also be used to refer to parameters of the training process itself, such as a learning rate of the training process. In some examples, the hyperparameters of the model are specified based on the task the model is being created for, such as the type of data the model is to use, the goal of the model (e.g., classification, regression, anomaly detection), etc. The hyperparameters may also be specified based on other design goals associated with the model, such as a memory footprint limit, where and when the model is to be used, etc.

Model type and model architecture of a model illustrate a distinction between model generation and model training. The model type of a model, the model architecture of the model, or both, can be specified by a user or can be automatically determined by a computing device. However, neither the model type nor the model architecture of a particular model is changed during training of the particular model. Thus, the model type and model architecture are hyperparameters of the model and specifying the model type and model architecture is an aspect of model generation (rather than an aspect of model training). In this context, a “model type” refers to the specific type or sub-type of the machine-learning model. As noted above, examples of machine-learning model types include, without limitation, perceptrons, neural networks, support vector machines, regression models, decision trees, Bayesian models, Boltzmann machines, adaptive neuro-fuzzy inference systems, as well as combinations, ensembles and variants of these and other types of models. In this context, “model architecture” (or simply “architecture”) refers to the number and arrangement of model components, such as nodes or layers, of a model, and which model components provide data to or receive data from other model components. As a non-limiting example, the architecture of a neural network may be specified in terms of nodes and links. To illustrate, a neural network architecture may specify the number of nodes in an input layer of the neural network, the number of hidden layers of the neural network, the number of nodes in each hidden layer, the number of nodes of an output layer, and which nodes are connected to other nodes (e.g., to provide input or receive output). As another non-limiting example, the architecture of a neural network may be specified in terms of layers. To illustrate, the neural network architecture may specify the number and arrangement of specific types of functional layers, such as long-short-term memory (LSTM) layers, fully connected (FC) layers, convolution layers, etc. While the architecture of a neural network implicitly or explicitly describes links between nodes or layers, the architecture does not specify link weights. Rather, link weights are parameters of a model (rather than hyperparameters of the model) and are modified during training of the model.

In many implementations, a data scientist selects the model type before training begins. However, in some implementations, a user may specify one or more goals (e.g., classification or regression), and automated tools may select one or more model types that are compatible with the specified goal(s). In such implementations, more than one model type may be selected, and one or more models of each selected model type can be generated and trained. A best performing model (based on specified criteria) can be selected from among the models representing the various model types. Note that in this process, no particular model type is specified in advance by the user, yet the models are trained according to their respective model types. Thus, the model type of any particular model does not change during training.

Similarly, in some implementations, the model architecture is specified in advance (e.g., by a data scientist); whereas in other implementations, a process that both generates and trains a model is used. Generating (or generating and training) the model using one or more machine-learning techniques is referred to herein as “automated model building.” In one example of automated model building, an initial set of candidate models is selected or generated, and then one or more of the candidate models are trained and evaluated. In some implementations, after one or more rounds of changing hyperparameters and/or parameters of the candidate model(s), one or more of the candidate models may be selected for deployment (e.g., for use in a runtime phase).

Certain aspects of an automated model building process may be defined in advance (e.g., based on user settings, default values, or heuristic analysis of a training data set) and other aspects of the automated model building process may be determined using a randomized process. For example, the architectures of one or more models of the initial set of models can be determined randomly within predefined limits. As another example, a termination condition may be specified by the user or based on configurations settings. The termination condition indicates when the automated model building process should stop. To illustrate, a termination condition may indicate a maximum number of iterations of the automated model building process, in which case the automated model building process stops when an iteration counter reaches a specified value. As another illustrative example, a termination condition may indicate that the automated model building process should stop when a reliability metric associated with a particular model satisfies a threshold. As yet another illustrative example, a termination condition may indicate that the automated model building process should stop if a metric that indicates improvement of one or more models over time (e.g., between iterations) satisfies a threshold. In some implementations, multiple termination conditions, such as an iteration count condition, a time limit condition, and a rate of improvement condition can be specified, and the automated model building process can stop when one or more of these conditions is satisfied.

Another example of training a previously generated model is transfer learning. “Transfer learning” refers to initializing a model for a particular data set using a model that was trained using a different data set. For example, a “general-purpose” model can be trained to detect anomalies in vibration data associated with a variety of types of rotary equipment, and the general-purpose model can be used as the starting point to train a model for one or more specific types of rotary equipment, such as a first model for generators and a second model for pumps. As another example, a general-purpose natural-language processing model can be trained using a large selection of natural-language text in one or more target languages. In this example, the general-purpose natural-language processing model can be used as a starting point to train one or more models for specific natural-language processing tasks, such as translation between two languages, question answering, or classifying the subject matter of documents. Often, transfer learning can converge to a useful model more quickly than building and training the model from scratch.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

As another example, to use supervised training to train a model to perform a classification task, each data element of a training data set may be labeled to indicate a category or categories to which the data element belongs. In this example, during the creation/training phase, data elements are input to the model being trained, and the model generates output indicating categories to which the model assigns the data elements. The category labels associated with the data elements are compared to the categories assigned by the model. The computer modifies the model until the model accurately and reliably (e.g., within some specified criteria) assigns the correct labels to the data elements. In this example, the model can subsequently be used (in a runtime phase) to receive unknown (e.g., unlabeled) data elements, and assign labels to the unknown data elements. In an unsupervised training scenario, the labels may be omitted. During the creation/training phase, model parameters may be tuned by the training algorithm in use such that during the runtime phase, the model is configured to determine which of multiple unlabeled “clusters” an input data sample is most likely to belong to.

As another example, to train a model to perform a regression task, during the creation/training phase, one or more data elements of the training data are input to the model being trained, and the model generates output indicating a predicted value of one or more other data elements of the training data. The predicted values of the training data are compared to corresponding actual values of the training data, and the computer modifies the model until the model accurately and reliably (e.g., within some specified criteria) predicts values of the training data. In this example, the model can subsequently be used (in a runtime phase) to receive data elements and predict values that have not been received. To illustrate, the model can analyze time series data, in which case, the model can predict one or more future values of the time series based on one or more prior values of the time series.

In some aspects, the output of a model can be subjected to further analysis operations to generate a desired result. To illustrate, in response to particular input data, a classification model (e.g., a model trained to perform classification tasks) may generate output including an array of classification scores, such as one score per classification category that the model is trained to assign. Each score is indicative of a likelihood (based on the model's analysis) that the particular input data should be assigned to the respective category. In this illustrative example, the output of the model may be subjected to a softmax operation to convert the output to a probability distribution indicating, for each category label, a probability that the input data should be assigned the corresponding label. In some implementations, the probability distribution may be further processed to generate a one-hot encoded array. In other examples, other operations that retain one or more category labels and a likelihood value associated with each of the one or more category labels can be used.

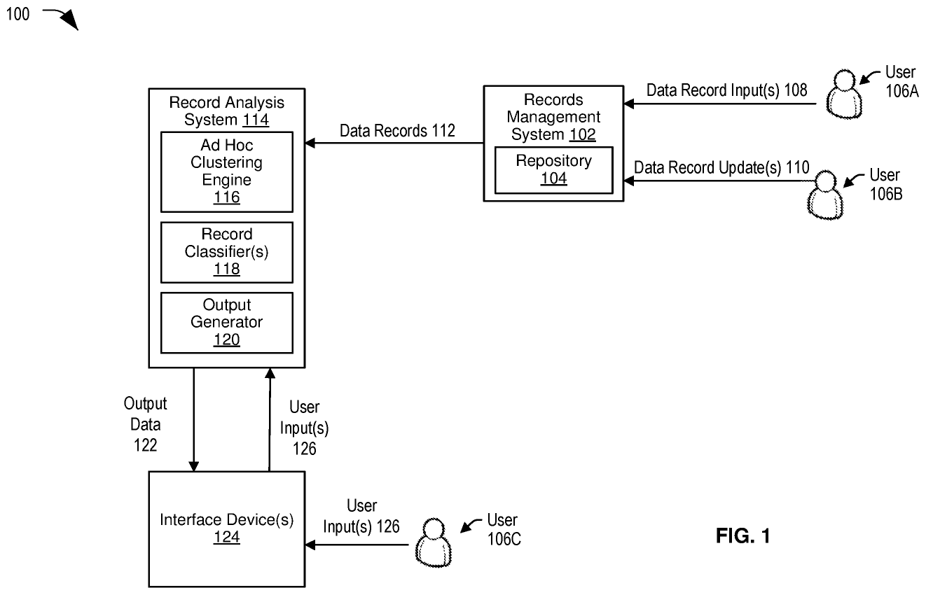

FIG. 1 is a block diagram of an example of a system 100 that is configured to perform operations associated with ad hoc analysis of data records that include textual content. In the example illustrated in FIG. 1, the system 100 includes a record analysis system 114 that is coupled to or otherwise has access to data records 112 of a records management system 102. Additionally, in the example illustrated in FIG. 1, one or more interface devices 124 are coupled to the record analysis system 114. In some implementations, the interface device(s) 124 are integrated with the record analysis system 114. For example, the record analysis system 114 may include, correspond to, or be included within a computing device, and the interface device(s) 124 may be portions of the computing device. In other examples, one or more of the interface device(s) are indirectly coupled to the record analysis system 114. For example, the record analysis system 114 may include software instructions executed at one or more server computing devices, and the interface device(s) 124 may interact with the record analysis system 114 via one or more networks.

The records management system 102 includes a repository 104 to store the data records 112 based on data record inputs 108, data record updates 110, or both. In a particular aspect, at least one data field of the data records 112 is a text field that stores unstructured (e.g., natural language) text. For example, the records management system 102 may include or correspond to a work order management system. In this example, the data record input(s) and update(s) 108, 110 may include text descriptions reporting problems, text descriptions of operations performed to troubleshoot problems, text descriptions of the status of actions taken to resolve the problems, and/or other text remarks providing additional information about the problems. In this example, the data records 112 store information about problems experienced by users 106 and actions performed to resolve the problems, but since much of the information is in natural language text, it can be challenging to analyze to recognize trends, etc. The record analysis system 114 is configured to perform operations to facilitate analysis of such data records 112.

Although the example above describes the record management system 102 as a work order management system, in other examples, record management system 102 is configured to store other types of data records 112 instead of or in addition to work order records. For example, the record management system 102 may include a library records system or a user reviews system. In either of these examples, significant information in each record may be stored in unstructured text (often input by different users 106) resulting in significant challenges in automating extraction of information to generate trends from and/or to assign classification labels to the data records 112.

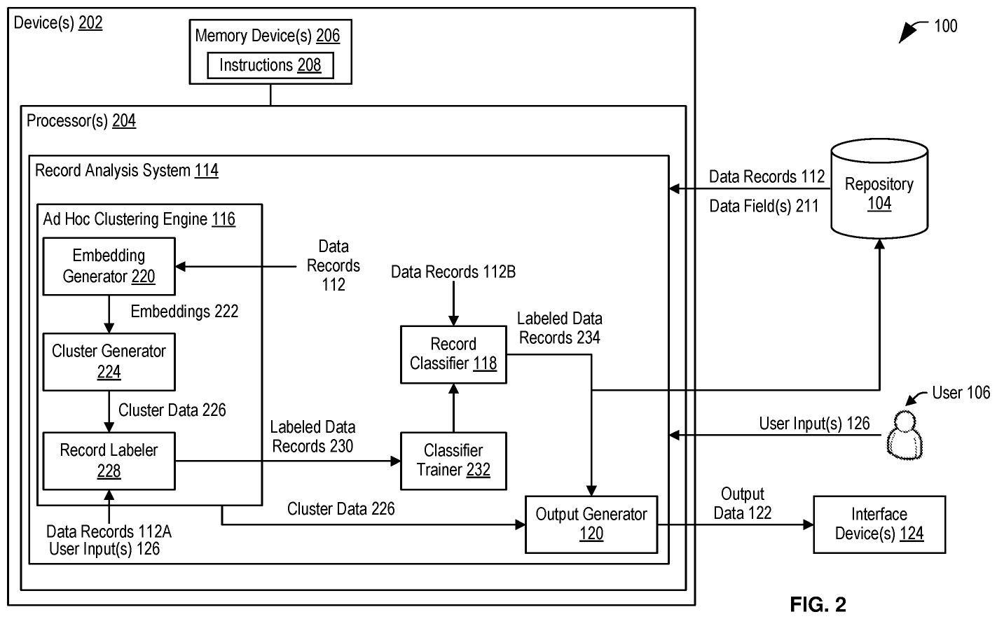

The record analysis system 114 is a machine learning based system that is configured to perform operations to facilitate analysis of the data records 112. In the example illustrated in FIG. 1, the record analysis system 114 includes an ad hoc clustering engine 116, a record classifier 118, and an output generator 120. In other examples, the record analysis system 114 includes additional components, such as a classifier trainer as described with reference to FIG. 2.

The ad hoc clustering engine 116 is configured to perform clustering operations in response to user input 126 from a user 106C. As an example, the user 106C may select one or more particular data fields of the data records 112 and initiate the clustering operations. In this example, the ad hoc clustering engine 116 generates clusters based on the particular data field(s), where the clusters group particular data records together based on semantic similarity of text content of the particular data field(s). To illustrate, if the user 106C selects a “remarks” data field, the ad hoc clustering engine 116 groups the data records 112 into two or more clusters, where each cluster includes two or more data records that have semantically similar content in the “remarks” data field. In some implementations, the user input 126 may cause the ad hoc clustering engine 116 to perform the clustering operations on only a specified subset of the data records 112. For example, the user 106C may indicate that the clustering operations based on the “remarks” data field are to be applied only to data records 112 with a timestamp within a particular range. In this example, each cluster generated by the ad hoc clustering engine 116 includes two or more data records that have semantically similar content in the “remarks” data field and a timestamp within the particular range. As another example, the user 106C may indicate that second clustering operations are to be applied only to data records 112 associated with a cluster generated by first clustering operations. To illustrate, the user 106C may cause the ad hoc clustering engine 116 to perform clustering based on a “remarks” data field to generate a first set of clusters. The user 106C may then select a particular cluster from among the first set of clusters and instruct the ad hoc clustering engine 116 to perform clustering operations based on a “problem description” data field. In this illustrative example, the ad hoc clustering engine 116 generates a second set of clusters based on semantic similarity of text of the problem description” data field of the data records 112 associated with the particular cluster that the user 106C selected from among the first set of clusters.

The record classifier(s) 118 are configured to assign category labels (e.g., classes) to the data records 112. According to a particular aspect, at least one record classifier of the record classifier(s) 118 is configured to assign a category label to a data record 112 based on semantic content of text of a data field of the data record 112. In some implementations, one or more of the category labels is a user-defined label. For example, at least a portion of the user input 126 provided by the user may specify a category label that is to be assigned by the record classifier(s) 118.

In some implementations, the record classifier(s) 118 are trained based on clusters generated by the ad hoc clustering engine 116. For example, after the ad hoc clustering engine 116 generates clusters based on at least a subset of the data records 112, the user 106C may specify a category label that is to be associated with a particular cluster. In this example, the category label may be used, along with data representing the data records 112 assigned to the particular cluster (and possibly other data) to generate training data that is used to train or update at least one of the record classifier(s) 118. For example, a first record classifier 118 may be modified or replaced to provide a second record classifier 118 that is trained to assign the user-specified category label to other data records 112.

The user-specified category label can be used as a common nomenclature to facilitate further data analysis. For example, a category label that summarizes a particular type of equipment failure can be added to data records 112 that include text descriptive of such an equipment failure. In this example, the data records 112 of the data repository 104 can then be filtered or otherwise processed (e.g., binned by date or duration of occurrence) to provide additional insights into the information contained in text in the data records 112.

The category labels also facilitates searching for particular records from among a large number of records of the repository 104. To illustrate, the record analysis system 114 can dynamically train or retrain the record classifier(s) 118 in response to user input in order to label the data records 112 in a particular way. Additionally, the category labels and/or clusters generated by the ad hoc clustering engine 116 can be used to filter the data records to help the user 106C identify particular records of interest. As a result, time and resources (including computing time and network bandwidth) spent analyzing the data records can be conserved.

The output generator 120 is configured to provide output data 122 to the interface device(s) 124. In some examples, the output data 122 includes information to display one or more graphical user interface (GUI) screens at the interface device(s) 124. In such examples, the GUI screen(s) are configured to receive input from the user 106 (e.g., the user input 126) as text, pointer movements, selections, gestures, voice commands, other input modalities, or combinations thereof. In a particular implementation, one or more of the GUI screen(s) are configured to display results of the clustering operations performed by the ad hoc clustering engine 116. In the same or different implementation, one or more of the GUI screen(s) are configured to receive user input 126 specifying one or more data fields upon which clustering operations are to be based, user input specifying one or more category labels to be assigned to data records associated with a cluster, or other user input to manipulate or filter the data records 112. In the same or different implementation, one or more of the GUI screen(s) are configured to use the output of the ad hoc clustering engine 116, the output of the record classifier 118, or both, to generate a display representing trends in the data records 118.

Thus, the system 100 facilitates efficient analysis of collections of data records (such as data records 112 of the repository 104 of the record management system 102) where relevant content of the data records is contained in text in one or more unstructured data fields. The system 100 improves the functioning of a computer system by performing an analysis of such unstructured data fields to identify semantically related data records, provide automated labeling of data records for further analysis, or both. Further, the system 100 reduces the processing time and resources (as well as user time and effort) required to identify patterns in textual content of the data records 112 as compared to traditional techniques. In addition, the automated clustering prior to assignment of labels based on user input simplifies generation of training data such that ordinary users (e.g., domain experts rather than machine learning experts) can generate the training data, which reduces cost and may improve accuracy of the generated training data.

FIG. 2 is a block diagram that illustrates further detail of aspects of a particular implementation of the system 100 of FIG. 1. In particular FIG. 2 illustrates details of one implementation of the record analysis system 114. In the example illustrated in FIG. 2, the record analysis system 114 includes or corresponds to software (e.g., computer-executable instructions) that are executed at one or more devices 202. The device(s) 202 include one or more memory devices 206 and one or more processors 204. The processor(s) 204 are configured to execute instructions 208 from the memory device(s) 206 to perform various operations described herein, such as operations of the record analysis system 114.

In FIG. 2, the device(s) 202 include or are coupled to the repository 104 to access the data records 112. Additionally, in FIG. 2, the device(s) 202 include or are coupled to the interface device(s) 124 to display information to the user 106, to receive user input 126, or both.

In the example illustrated in FIG. 2, the instructions 208 include instructions to implement the record analysis system 114 as firmware or software executable by the processor(s) 210. The memory device(s) 206 may also store one or more other applications, such as a file system browser, an internet browser, document generation applications (e.g., a word processor), an application to interface with the record management system 102 of FIG. 1, etc.

In FIG. 2, the record analysis system 114 includes the ad hoc clustering engine 116, the record classifier 118, and the output generator 120 described with reference to FIG. 1. The ad hoc clustering engine 116 in the example of FIG. 2 includes an embedding generator 220, a cluster generator 224, and a record labeler 228. In other implementations, the ad hoc clustering engine 116 includes more, fewer, or different components. For example, in some implementations, the embedding generator 220 is omitted from the ad hoc clustering engine 116. In such implementations, embeddings (e.g., embedding vectors) representing the data records 112 or data fields of the data records 112 may be generated by one or more embedding generators 220 that are distinct from the ad hoc clustering engine 116. To illustrate, the record management system 102 of FIG. 1 may include an embedding generator that generates one or more embeddings for a particular data record when the data record is added to the repository 104. As another example, in some implementations, the record labeler 228 is omitted from the ad hoc clustering engine 116. In such implementations, the record labeler 228 and a classifier trainer 232 may be integrated into a machine-learning training component that combines aspects of generating training data and training the record classifier 118.

The embedding generator 220 is configured to generate embeddings 222 representing the data records 112. The embeddings 222 are vectors or arrays of values that represent the semantic (or semantic and syntactic) relationships among words in the text of one or more data fields. Conceptually, an embedding 222 can be viewed as defining coordinates of a point in a high-dimensional (e.g., tens to hundreds of dimensions) embedding space. In a particular example, the embedding generator 220 includes one or more embedding networks (e.g., one or more neural networks trained to generate the embeddings 222 based on input text). Each embedding 222 represents at least a portion of the text of at least one data field 211 of one data record 112. For example, when the data records 112 include a “remarks” data field, a particular one of the embeddings 222 represents at least a portion of the text stored in the “remarks” data field in a particular one of the data records 112. In some implementations, each embedding 222 is a field embedding which represents the entire text content (possibly excluding stop words) of one data field for one data record 112. In other implementations, each embedding 222 is a record embedding which represents the text content (possibly excluding stop words) of two or more data fields for one data record 112.

The cluster generator 224 is configured to generate cluster data 226 identifying groups (i.e., clusters) of embeddings 222. Each cluster includes two or more embeddings 222 that are near one another in the embedding space. The cluster generator 224 may use any of various automatic clustering techniques, such as density-based clustering using, for example, a Density-Based Spatial Clustering of Applications with Noise (DBSCAN) algorithm, a hierarchical DBSCAN (HDBSCAN) algorithm, an Ordering Points To Identify the Clustering Structure (OPTICS) algorithm, an Automatic Local Density Clustering Algorithm (ALDC) algorithm, or similar techniques. Since the embeddings 222 represent semantic content of text, when embeddings 222 are treated as points in the embedding space, locations that are closer to one another represent text that is more semantically similar than text represented by locations that are farther away from one another. Thus, when the cluster generator assigns two embeddings 222 to a particular cluster, this is an indication that the two embeddings 222 share some common semantic features, even if different terms are used in the text represented by the two embeddings 222.

The cluster data 226 includes information to uniquely designate each cluster identified by the cluster generator 224. Generally, each cluster is initially designated by a automatically assigned identifier, such as a computer-assigned alphanumeric value. The cluster data 226 also includes information that maps to the data records 112 assigned to each cluster. Thus, while the clusters represent groups of points in embeddings, the cluster data 226 enables mapping of each cluster to a group of data records 112. As such, the clusters are also referred to herein as groups of data records 112.

In the example illustrated in FIG. 2, the cluster data 226 is provided to the output generator 120 to generate output data 122, such as a GUI, that is presented to the user 106. In this example, the GUI includes information such as, for example, the number of clusters identified, the name of the data field(s) upon which the clusters are based, summary information describing each cluster (e.g., representative text or topics for each cluster), data records associated with one or more of the clusters, etc. The user 106 can provide user input(s) 126 to modify the GUI. For example, the user 106 can filter the information displayed to show only data records 112 associated with a particular cluster. As another example, the user 106 can select two or more of the clusters to be merged to form a single combined cluster. To illustrate, if the user 106 determines that two clusters are sufficiently related, the user 106 can provide user input 126 to merge the two clusters. In another example, the user 106 can provide user input 126 to perform further clustering operations. To illustrate, the user 106 can select a particular cluster (associated with a first group of data records 112) and a second data field and instruct the cluster generator 224 to perform clustering based on text of the second data field of the data records of the first group of data records 112.

In some implementations, the user 106 can also apply user-defined category labels to one or more of the clusters. For example, in FIG. 2, the cluster data 226 and user input 126 is provided to the record labeler 228. In this example, the user input 126 specifies a particular cluster of the cluster data 226 and indicates the user-defined category label to be assigned to data records 112A that are associated with the particular clusters. Based on the user input 126, the record labeler 228 generates labeled data records 230. The labeled data records 230 may be stored in the repository 104 (e.g., by adding the user-defined category labels to the data records 112A.

Additionally, in some implementations, the labeled data records 230 may be provided to a classifier trainer 232 to generate training data to train or update the record classifier 118. As an example, the record classifier 118 may include a neural network that is configured to receive embeddings 222 representing data records 112B that were not labeled by the user 106 as input and to generate output indicating a class (corresponding to a category label) to which the embedding 222 is predicted to belong. Using the record classifier 118 to predict category labels assigned to particular data records 112 simplifies the process of data analysis for the user 106. The predicted classification of the data records 112B can be used to generate labeled data records 234, which can be stored in the repository 104 and/or provided as output to the user 106 via the output generator 120. In a particular aspect, category labels assigned by the record classifier 118 are distinguished from category labels assigned by the user 106.

In a particular aspect, the classifier trainer 232 uses an automated model building process to generate the record classifier 118. In some implementations, the classifier trainer 232 is configured to generate multiple record classifiers 118. In such implementations, a best performing one of the record classifiers 118 may be retained for use. Alternatively, two or more record classifiers 118 may be retained for use. To illustrate, a first record classifier 118 may be retained for use in assigning category labels based on a first data field 211 (e.g., a “problem report” data field), and a second record classifier 118 may be retained for use in assigning category labels based on a second data field 211 (e.g., a “remarks” data field). In various implementations, the record classifier 118 may include one or more of a neural network-based classifier, a decision tree-based classifier, a support vector machine-based classifier, a naive B ayes-based classifier, a classifier using another machine learning process, or any combination thereof.

FIG. 3 is a block diagram that illustrates further detail of aspects of a particular implementation of the system of FIGS. 1 and 2. In particular, FIG. 3 illustrates aspects of the embedding generator 220 according to a particular implementation.

In FIG. 3, the data records 112 include a first data record 310A and a second data record 310B. The first data record 310A includes a record identifier 320A (“rec. ID” in FIG. 3), a field value 322A of a data field 302, and a field value 324A of a data field 304. Also, the second data record 310A includes a record identifier 320B, a field value 322B of the data field 302, and a field value 324B of the data field 304. Each of the record identifiers 320 is a unique identifier of the respective data record 310. The data fields 302, 304 are text fields. That is, the field values 322, 324 include natural language text. Although each data record 310 illustrated in FIG. 3 includes two data fields, it should be understood that each data record 310 may include more than two data fields, which may include text fields, numeric fields, logical data fields, timestamps, or data fields storing other types of data. Additionally, although two data records 310 are illustrated in FIG. 3, the data records 112 may include more than two data records 310.

In the example illustrated in FIG. 3, a data record 310 is provided as input to one or more field embedding generators 350 of the embedding generator 220. In a particular implementation, each of the field embedding generator(s) 350 is configured to generate an embedding representing text content of a particular data field of the data record 310. For example, a first field embedding generator 350 may generate a field embedding 332A based on text content (e.g., the field value 322A) of the data field 302 of the data record 310A and may generate a field embedding 332B based on text content (e.g., the field value 322B) of the data field 302 of the data record 310B. In this example, a second field embedding generator 350 may generate a field embedding 334A based on text content (e.g., the field value 324A) of the data field 304 of the data record 310A and may generate a field embedding 334B based on text content (e.g., the field value 324B) of the data field 304 of the data record 310B. In other implementations, a single field embedding generator 350 generates all of the field embeddings 332, 334, irrespective of which data field 302, 304 the text content is stored in.

In the example illustrated in FIG. 3, the field embeddings 332, 334 for a particular data record 310 are provided as input to the record embedding generator 360 to generate a record embedding 318 representing the text content of multiple data fields 302, 304 of the data record 310. In other examples, the record embedding generator 360 is omitted. Thus, for a particular data record 310 input to the embedding generator 220, the embedding generator 220 generates one or more embeddings 370 as output. The embedding(s) 370 include, for each data record 310, one or more field embeddings 332, 334, a record embedding 318, or a combination thereof. For example, in FIG. 3, the embeddings 222 representing the data records 112 include a record embedding 318A representing the data record 310A and associated with the record identifier 320A of the data record 310A, as well as a field embedding 332A representing the field value 322A and a field embedding 334A representing the field value 324A. Additionally, in FIG. 3, the embeddings 222 include a record embedding 318B representing the data record 310B and associated with the record identifier 320B of the data record 310B, as well as a field embedding 332B representing the field value 322B and a field embedding 334B representing the field value 324B.

In a particular implementation, the embeddings 222 are generated on-demand (e.g., in an ad hoc manner in response to a specific user request). For example, in response to a user selecting the data field 302 for clustering analysis, the field values 322 associated with the data field 302 may be provided as input to the field embedding generator 350 to generate the embeddings 222. In another particular implementation, the embeddings 222 are generated off-line. For example, the embedding(s) 370 representing a particular data record 310 may be generated when the data record 310 is added to the data repository 104 of FIGS. 1 and 2.

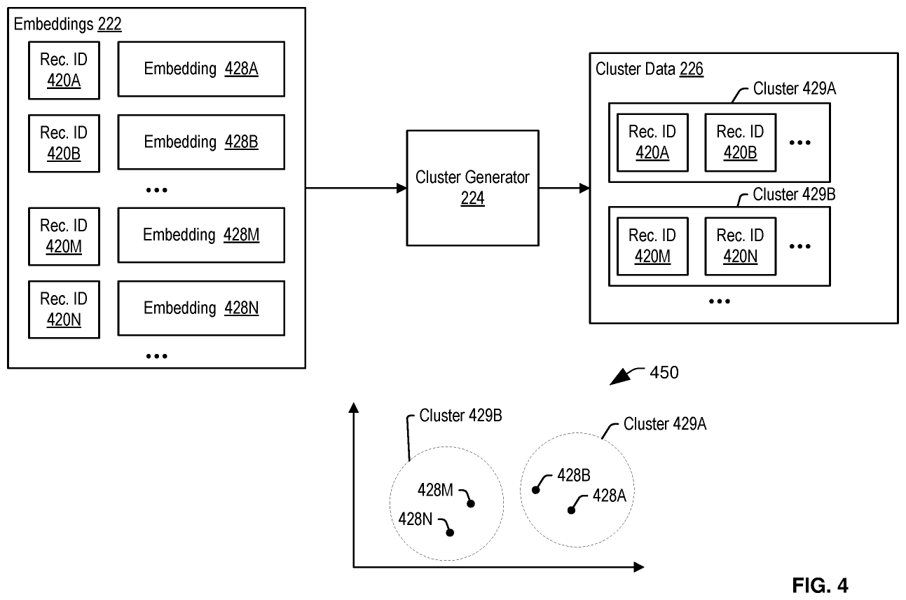

FIG. 4 is a block diagram that illustrates further detail of aspects of a particular implementation of the system of FIGS. 1 and 2. The example of FIG. 4 illustrates aspects of cluster generation in a particular implementation.

In the example illustrated in FIG. 4, the embeddings 222 are provided as input to the cluster generator 224 to generate the cluster data 226. In FIG. 4, the embeddings 222 include an embedding 428 for each of a plurality of data records, each associated with a respective record identifier 420 (“rec. ID” in FIG. 4). For example, a data record associated with record identifier 420A is represented by embedding 428A, a data record associated with record identifier 420B is represented by embedding 428B, a data record associated with record identifier 420M is represented by embedding 428M, and a data record associated with record identifier 420N is represented by embedding 428N.

The embeddings 428, or the embeddings 428 and their respective record identifiers 420, are provided as input to the cluster generator 224. As explained above, each embedding 428 can be considered to represent a point in an embeddings space, illustrated in two dimensions by diagram 450. The cluster generator 224 identifies groups of embeddings 428 that are near to one another in the embedding space. For example, in the diagram 450, the embedding 428N is closer to the embedding 428M than to either of the embeddings 428B and 428A. Proximity of two embeddings in the embedding space corresponds to semantic similarity of text content used to generate the two embeddings. Thus, the text content used to generate the embedding 428N is more similar to the text content used to generate the embedding 428M than it is to the text content used to generate either of the embeddings 428A and 428B. In a particular example, the cluster generator 224 determines that two or more embeddings 428 represent a cluster 429 based on various parameters, such as density of embeddings 428 within a particular region of the embedding space.

When the cluster generator 224 identifies a cluster 429, the cluster generator 224 outputs cluster data 226 representing the cluster 429. The cluster data 226 enables a user (e.g., one of the users 106 of FIGS. 1 and 2) or a device (e.g., the device 202 or the processor(s) 204 of FIG. 2) to identify specific data records associated with the cluster. For example, in FIG. 4, the cluster data 226 indicates that data records associated with record identifiers 420A and 420B are associated with cluster 429A and data records associated with record identifiers 420M and 420N are associated with cluster 429B. Thus, the cluster data 226 enables a user or device to select a particular cluster 429 in order to specify operations that are to be performed with respect to a set of data records. For example, the user 106 of FIG. 2 can request that information presented in a GUI be filtered to display only information associated with data records assigned to the cluster 429A.

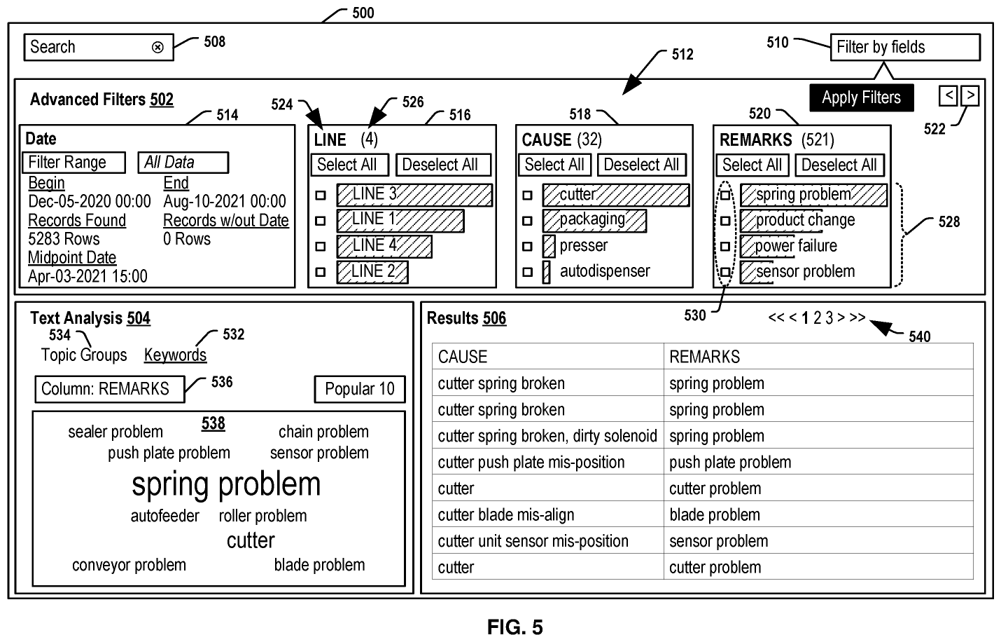

FIGS. 5-8 illustrate examples of graphical user interfaces (GUIs) that may be generated by the output generator 120 for display via the interface device(s) 124 of any of FIGS. 1 and 2. In the examples illustrated in FIGS. 5-8, the GUIs display information derived from the data records 112 and include selectable options to perform searching, filtering, labeling and/or other analysis of the data records 112. For ease of illustration and to mimic familiar user interfaces, the GUIs are illustrated as including tabs, checkboxes, text boxes, buttons, icons, and/or other visual cues and selectable options. However, in other implementations, different visual cues and selectable options may be used to present the same information. In still other implementations, the GUIs may present more, less, or different information than is shown in FIGS. 5-8. Further, the visual cues and selectable options may be arranged in a “ribbon” or tool bar in the GUIs. As another example, the visual cues and selectable options may be accessible via context menus.

The GUIs provide a user with a simplified interface to observe and analyze data within the repository 104 of the records management system 102 of FIG. 1. Further, the GUIs enable a user of the records management system 102 (e.g., a domain expert rather than a data scientist) to perform data analysis of data records that include text content, thereby reducing or avoiding the time and expense associated with manual analysis of the data records (e.g., by a data scientist). Even further, the GUIs enable the user of the records management system 102 to identify trends or other systemic problems based, at least in part, on natural language text in the data records 112.

FIG. 5 is a diagram illustrating an example of a GUI 500 that may be generated by the system of FIG. 1 in particular implementations. In the example illustrated in FIG. 5, the GUI 500 includes several sections, including an advanced filters section 502, a text analysis section 504, and a results section 506. The GUI 500 also includes a search input 508 that allows a user to input search criteria to search the data records. The GUI 500 also includes a filter by fields selection 510 that provide selection options to filter the data records.

The advanced filters section 502 in FIG. 5 includes a plurality of data facets 512 of data from the repository 104. In this context, a “data facet” refers to an aspect of the data, such as content of a data field, content of two or more data fields, or information summarizing or aggregating content of one or more data fields. In FIG. 5, the data facets 512 of the data include a date facet 514, a line facet 516, a cause facet 518, and a remarks facet 520. The advanced filters section 502 also includes navigation options 522, which are selectable to change the specific data facets 512 that are displayed. For example, the data records 112 may include a “problem report” data field, which may be used to generate a problem report facet that can be displayed by interaction with the navigation options 522.

The data facets 512 include controls to enable filtering information displayed in the results section 506. For example, the date facet 514 includes a selection to specify a filter range and a selection to select all data (e.g., to not filter based on timestamps). As another example, each of the line facet 516, the cause facet 518, and the remarks facet 520 includes a set of check boxes 530 adjacent to data bars 528. Each of the data bars 528 represents information based on a data field associated with the particular data facet 512, as described further below, and each of the check boxes is selectable to filter data displayed based on particular values of the data field. In a particular aspect, the results section 506 displays filtered data records (or portions of filtered data records) based on selection(s) and/or user input indicated via the data facets 512. Information displayed in the results section 506 may also be filtered responsive to selections or user input received via the text analysis section 504.

In addition to selectable controls, each of the data facets 512 includes a name 524 (e.g., “Line” for the line facet 516) of the specific data field represented by the particular data facet 512. Additionally, each of the data facets 512 includes a counter 526 (e.g., a counter value of “4” associated with the line facet 516) that indicates how many different values of the data field are represented in the data records based on current filter settings. For example, in FIG. 5, the only filter setting in use is based on the data facet 514, and the counter 526 of the line facet 516 indicates that within the specified date range, the data records 112 include four different values in the line data field.

In FIG. 5, the date facet 514 enables selection of specific data records 112 based on timestamps of the data records. For example, in FIG. 5, the date range selected is from Dec. 5, 2020 to Aug. 10, 2021. The counter of the date facet 514 indicates that this date range includes 5283 rows, corresponding to 5283 data records. Information displayed in the other facets 512 and the other sections 504, 506 is filtered to include only the data records 112 that include timestamps within the specified date range.

The line facet 516, the cause facet 518, and the remarks facet 520 each provide a visual indication (e.g., data bars 528) indicating the number or relative number of data records having each of the different values of the respective data field. For example, in the line facet 516 of FIG. 5, the data bars 528 indicate that the filtered data records include more data records related to LINE 3 than data records related to LINE 1, LINE 4, or LINE 2, more data records related to LINE 1 than data records related to LINE 4 or LINE 2, and so forth.

The line facet 516 of FIG. 5 is one example of a data facet 512 that is based on a discrete data field of the data records 112. Discrete data fields of the data records 112 store structured data, such as a value indicating one of a limited number of selections logical values, or integers. To illustrate, in FIG. 5, the line facet 516 includes data related to specific production lines, of which there are a limited number (e.g., four in the example illustrated).

The cause facet 518 and the remarks facet 520 are examples of data facets 512 based on unstructured text data fields of the data records 112. In a particular aspect, the data bars 528 based on such fields are based on clustering operations performed by the ad hod clustering engine 116 of FIGS. 1 and 2, category labels assigned by the record classifier 118 of FIGS. 1 and 2, or a combination thereof. As one example, the remarks facet 520 includes a “spring problem” data bar that represents data records that include text assigned to a “spring problem” category by the record classifier 118 of FIGS. 1 and 2. As another example, the “spring problem” data bar represents data records that include text assigned to a particular cluster that is associated with automatically generated topic data including the text “spring problem.”

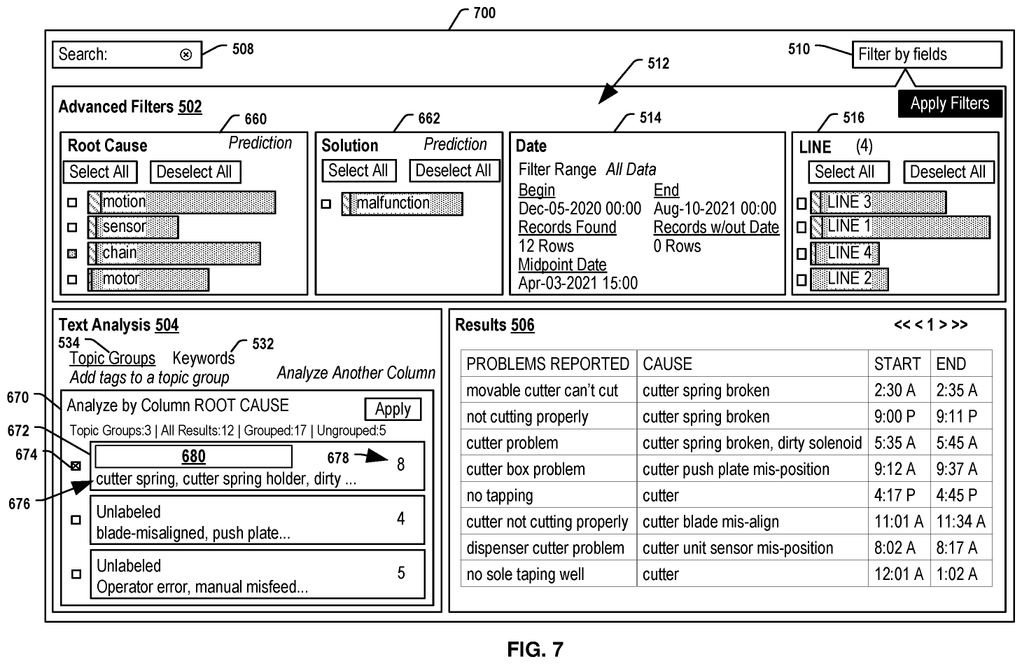

The text analysis section 504 includes user selectable options 532, 534 to select either a topic groups display or a keywords display. An example of a keywords display is illustrated in FIG. 5, and an example of a topic groups display is illustrated in FIG. 7. The keywords display of FIG. 5 includes a word cloud 538 representing common words (possibly excluding stop words) and/or common phrases in a data field indicated by a column selection 536.

In the example illustrated in FIG. 5, the results section 506 show summary information regarding text content of a cause data field and a remarks data field of data records that satisfy filter criteria specified in the advanced filters section 502. The specific data fields presented in the results section 506 may be selected via navigation controls 540 and/or via other user selectable controls. Although the results section 506 in the example of FIG. 5 shows summary information, in some implementations, the results section 506 shows the entire text content of one or more data fields of data records that satisfy filter criteria specified in the advanced filters section 502

When the results section 506, the data bars 528, or both, include summary information, the summary information may be generated using a machine-learning based topic model such as a latent semantic analysis algorithm. Alternatively, after the record classifier 118 of FIGS. 1 and 2 has been trained, the summary information may include classification labels assigned by the record classifier 118.

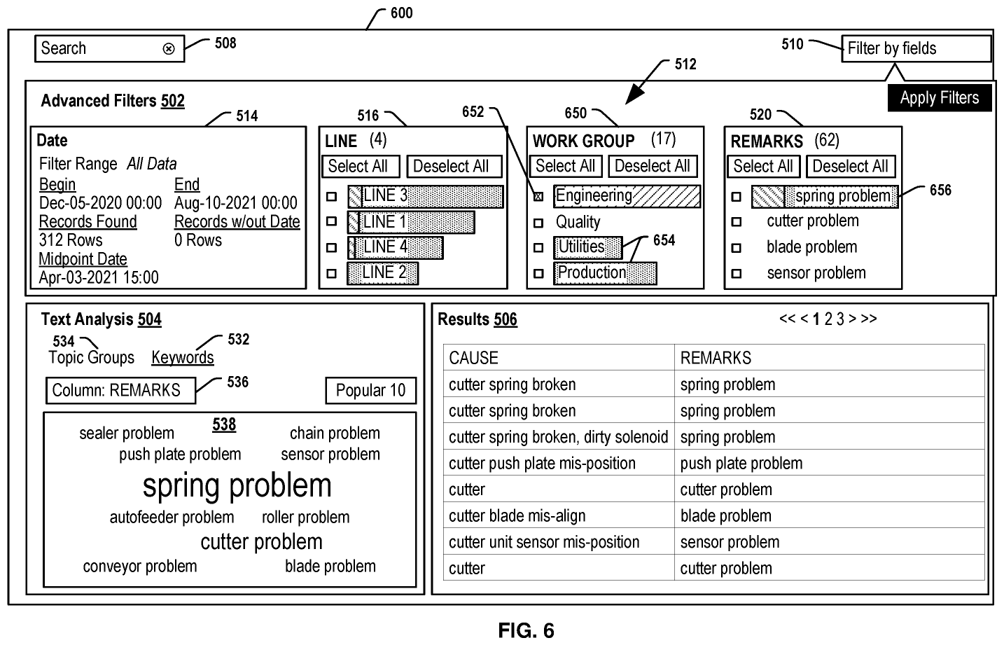

FIG. 6 is a diagram illustrating an example of a GUI 600 that may be generated by the system of FIG. 1 in particular implementations. The GUI 600 corresponds to the GUI 500 after updates based on user input. In the example illustrated in FIG. 6, the data facets 512 include a work group facet 650 representing data based on a work group data field of the data records 112. In this example, the work group data field is a discrete data field.

In FIG. 6, a selectable option 652 associated with an engineering work group has been selected, and information displayed in the data facets 512, the text analysis section 504, and the results section 506 has been filtered based on the selection. For example, a data bar associated with the engineering work group in the work group facet 650 has a first fill indicating that all of the data records represented in the work group facet 650 relate to the engineering work group (e.g., 17 data records as indicated by the counter of the show a full data bar for the engineering work group). In this example, the work group facet 650 also includes a data bars 654 for a utilities work group which has a second fill that is different from the first fill used for the engineering work group data bar. The second fill indicates data records that have timestamps within the date range specified in the date facet 514 but are not associated with the engineering work group. A data bar 656 illustrates another example in which some data records associated with the spring problems in the remarks data field relate to the engineering work group (as indicated by a portion of the data bar 656 with the first fill), and some data records associate with the spring problems in the remarks data field do not relate to the engineering work group (as indicated by a portion of the data bar 656 with the second fill).

FIG. 7 is a diagram illustrating an example of a GUI 700 that may be generated by the system of FIG. 1 in particular implementations. The GUI 700 corresponds to the GUI 500 after updates based on user input. In the example illustrated in FIG. 7, the data facets 512 include a root cause facet 660 representing data based on a root cause data field of the data records 112 and include a solution facet 662 representing data based on a solution data field of the data records 112. In this example, the root cause data field and the solution data field are unstructured text data fields. Additionally, categories associated with the data bars represented in the root cause facet 660 and the solution facet 662 are based on output of a machine learning model, such as the record classifier of FIGS. 1 and 2 or a topic model.

In FIG. 7, the topic groups option 534 has been selected in the text analysis section 504. As a result of selection of the topic groups option 534, cluster data 670 is displayed. The cluster data 670 represents clusters automatically generated by the ad hoc clustering engine 116 in response to user input, such as input selecting the topic groups option 534 and identifying a data field (e.g., the root cause data field) upon which to perform the cluster operations.

In the example illustrated in FIG. 7, the clusters are unlabeled, and topic data or summaries of content for each cluster are displayed. As an example, a graphical element 672 representing a first cluster includes a summary 676 of content associated with the first cluster. The summary 676 includes a set of words or phrases that are representative of the content of the first cluster. The words or phrases listed in the summary may be selected by a topic model or by selecting words or phrases that are common to the root cause data field of data records assigned to the first cluster. The graphical element 672 also includes a counter 678 indicating how many data records are assigned to the first cluster.

In FIG. 7, the graphical element representing each cluster is associated with a check box or other selection control. For example, the graphical element 672 is associated with check box 674. Selection of the check box associated with a particular cluster causes the data records display of the results section 506 to be filtered to show data records associated with the particular cluster. For example, in FIG. 7, the check box 674 is selected, and the results section 506 includes information from data records assigned to the first cluster.

Additionally, after selecting a particular cluster, such as the first cluster, the user can select another column (e.g., another data field) that is to undergo clustering operations. In this situation, the data records associated with the first cluster are subjected to clustering based on contents of the other data field. For example, in FIG. 7, the cluster data 670 is based on contents of the root cause data field, and the first cluster is associated with eight data records (as indicated by the counter 678). In response to selection of the check box 674 and selection of the solution data field, the ad hoc clustering engine 116 of FIGS. 1 and 2, performs clustering operations on the eight data records associated with the first cluster in order to generate clusters based on content of the solution data field of the eight data records.

In a particular aspect, a user can merge two or more of the clusters by selecting the check box associated with each cluster that is to be merged and selecting “apply” in the text analysis section 504. Additionally, in some implementations, one or more of the graphical elements representing the clusters includes a text box, such as text box 680 associated with the first cluster. Such text boxes are configured to receive user input specifying category labels that are to be assigned to the clusters. For example, a user can enter text, such as “cutter” into the text box 680 to assign the category label “cutter” to the root cause data field of each of the eight data records assigned to the first cluster. As explained with reference to FIG. 2, the user-defined category labels assigned in this manner can be used to generate labeled training data that is used to train or update the record classifier 118 of FIGS. 1 and 2.

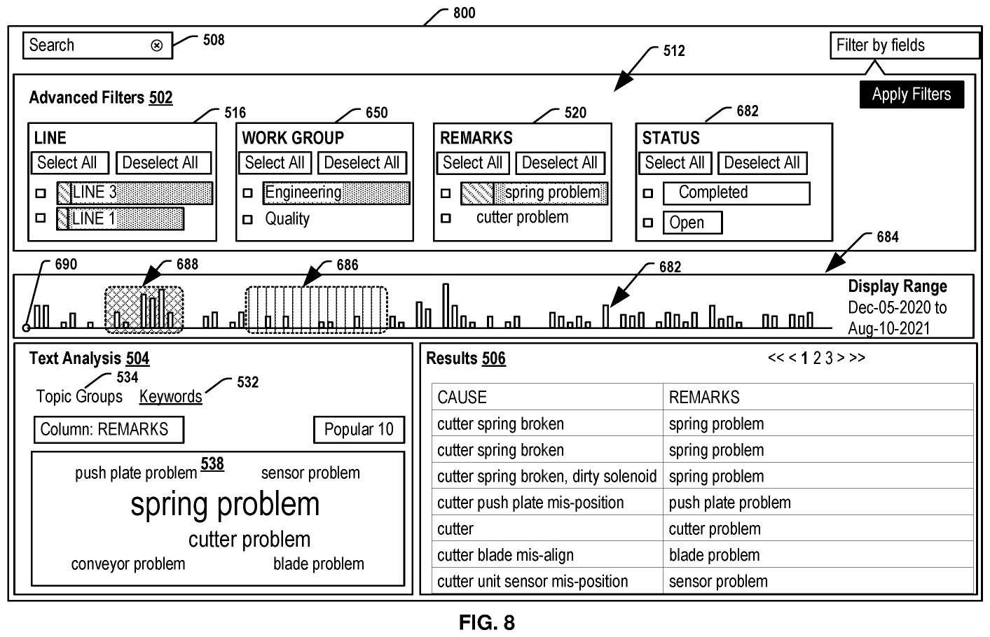

FIG. 8 is a diagram illustrating an example of a GUI 800 that may be generated by the system of FIG. 1 in particular implementations. The GUI 800 corresponds to the GUI 500 after updates based on user input or is an alternative to the GUI 500. In the example illustrated in FIG. 8, the advanced filters section 502, the text analysis section 504, and the results section 506 display information as described with reference to FIGS. 5-7 and include control elements that operate as described with reference to FIGS. 5-7. Additionally, the GUI 800 includes a time series section 684.

The time series section 684 provides a visual output to facilitate recognition of trends and/or anomalies during a time period. The specific time period displayed can be adjusted via a control element 690. To generate the time series section 684 particular data records (e.g., a filtered subset of the data records 112 of FIGS. 1 and 2) are selected. For example, the particular data records may be selected based on user input selecting among the selectable options of the advanced filter section 502, selecting among clusters identified in the text analysis section 504, or both. The particular data records are grouped into bins based on timestamps associated with each. For example, each bin may represent one shift, one day, one week, one month, one quarter, one year, or some other time period, and the particular data records may be grouped into the bins to indicate a count of data records associated with each bin.

The bins are represented in the time series section 684 by corresponding data bars, such as a data bar 682) where a dimension (e.g., a length) of the data bar represents a count of data records that satisfy binning criteria. The binning criteria include the filter criteria for selecting the particular data records that are binned, a moving window time range associated with each bin, or both. For example, the binning criteria may include filter settings that specify that the particular data records are to include only a subset of the data records 112 of FIGS. 1 and 2 that are related to the engineering work group and are from a cluster related to cutter problems, and that the bins are to each represent one day. In this example, the length of each data bar of the time series section 684 represents the number (e.g., count) of data records for each day that are related to cutter problems associated with the engineering work group. In some implementations, the data bars are generated dynamically (e.g., in response to user selection of particular binning criteria).

According to a particular aspect, the time series section 684 also visually distinguishes time periods that are associated with atypical counts of binned data records. For example, a period 688 is associated with an atypically high concentration of data records that satisfy the binning criteria and is associated with a graphical element (e.g., a box, a background fill pattern, a background color, a data bar fill pattern, a data bar color, etc.) that visually distinguishes the period 688 from other periods represented in the time series section 684. As another example, a period 686 is associated with an atypically low concentration of data records that satisfy the binning criteria and is associated with a graphical element (e.g., a box, a background fill pattern, a background color, a data bar fill pattern, a data bar color, etc.) that visually distinguishes the period 686 from other periods represented in the time series section 684

In a particular implementation, one or more periods that are associated with atypical count(s) of binned data records are identified based on a statistical analysis of the binned data records. For example, the output generator 120 of FIGS. 1 and 2 may determine a moving average count of the binned data records for each period represented in the time series section 684. A time window length used to determine the moving average count may be user-specified, may be a default value, or may be based on the binning criteria. For example, if the binning criteria specify that each bin should represent one day, then the time window length may be one week, or some other period representing several days. The moving average count of the binned data records may be compared to one or more thresholds, and a particular period is identified as associated with an atypical count of binned data records when the count of binned data records during the particular period deviates from the moving average count of data records by more than a threshold. In particular implementations, the threshold(s) are set based on variation of the counts of binned data records. For example, the threshold(s) may include a high count threshold of three standard deviations above the average and a low count threshold of four standard deviations below the average. In other examples, other multiples of the standard deviation are used for either the high count threshold, the low count threshold, or both. Alternatively, in some implementations, only one threshold may be used.

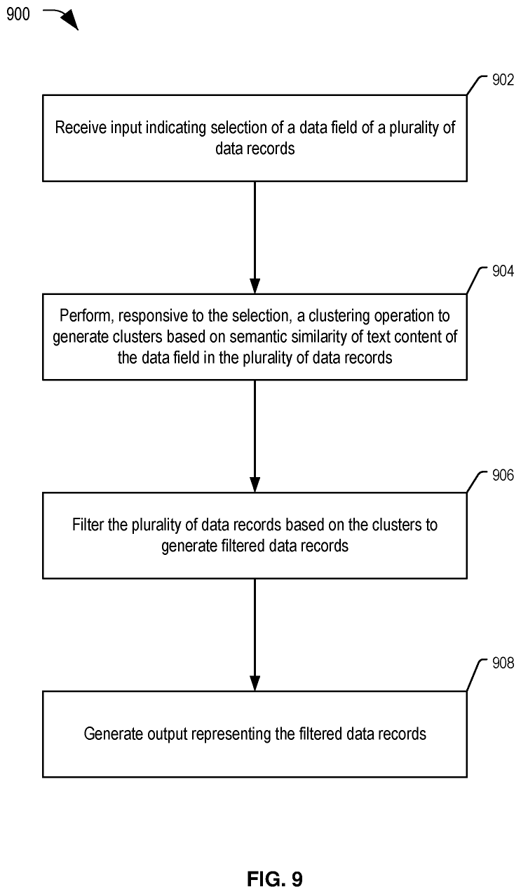

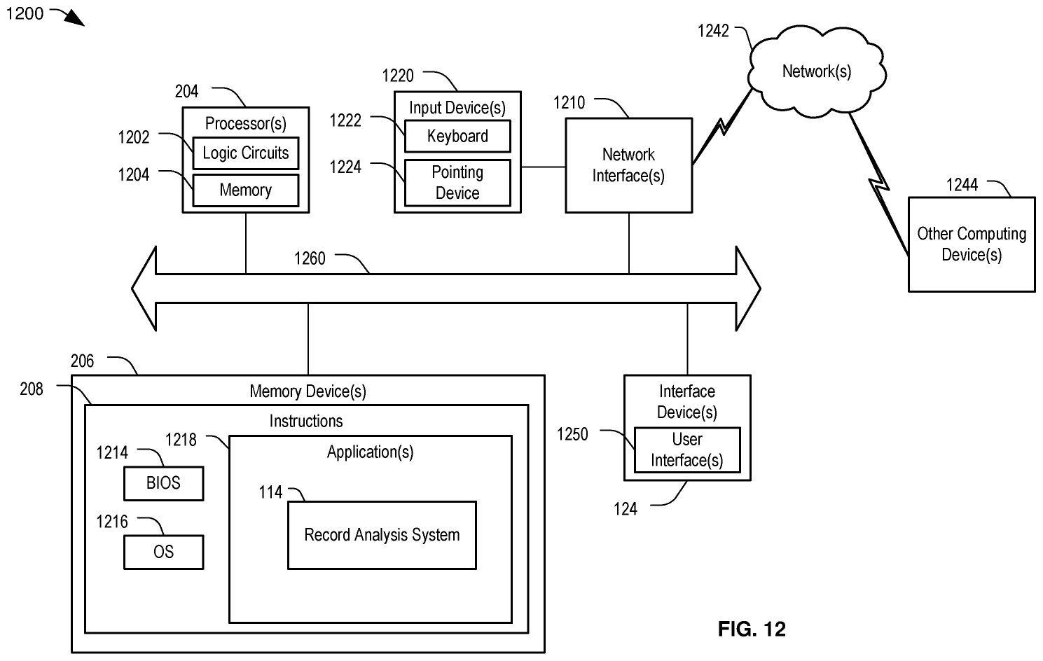

FIG. 9 is a flow chart of an example of a method 900 of ad hoc analysis of data records that include textual content. The method 900 may be performed by a computing device, such as the record analysis system 114 of FIG. 1, the device 202 of FIG. 2, a computing system 1200 of FIG. 12, or by a combination of any of the systems described herein.

The method 900 includes, at 902, receiving input indicating selection of a data field of a plurality of data records. For example, the record analysis system 114 of FIG. 1 or 2 may receive user input 126 selecting a particular data field (e.g., one or more of data field(s) 211 of FIG. 2). In this example, the particular data field is one of a group of data fields of the data records 112. In a particular aspect, the data fields of the data records 112 include at least one data field that stores text (e.g., natural language and/or unstructured text), and the data field selected from among the plurality of records includes or corresponds to one of the data fields that stores text.

The method 900 also includes, at 904, responsive to the selection, performing a clustering operation to generate clusters based on semantic similarity of text content of the data field in the plurality of data records. For example, the ad hoc clustering engine 116 of FIG. 1 or 2 may generate the clusters based on embeddings representing the text content of the data field for each data record 112. In this example, the embeddings can be treated as points in an embedding space, and proximity of two embeddings in the embedding space indicates semantic similarity of the text represented by the two embeddings. Each embedding can represent a subset of the text content of the data field in the particular data record (e.g., a phrase, clause, or sentence), the entire text content of the data field in the particular data record, or the text content of two or more data fields in the data record. In particular implementations, the clustering operations include density-based clustering operations, such that each cluster represents a region of high concentration of embeddings in the embedding space.

The method 900 further includes, at 906, filtering the plurality of data records based on the clusters to generate filtered data records, and at 908, generating output representing the filtered data records. For example, the cluster generator 224 or the output generator 120 can filter the data records based on results of the clustering operations. To illustrate, a user can select a particular cluster in the GUI 700 to filter information presented in the results section 506 of the GUI 700 to information derived from the data records of the selected cluster.

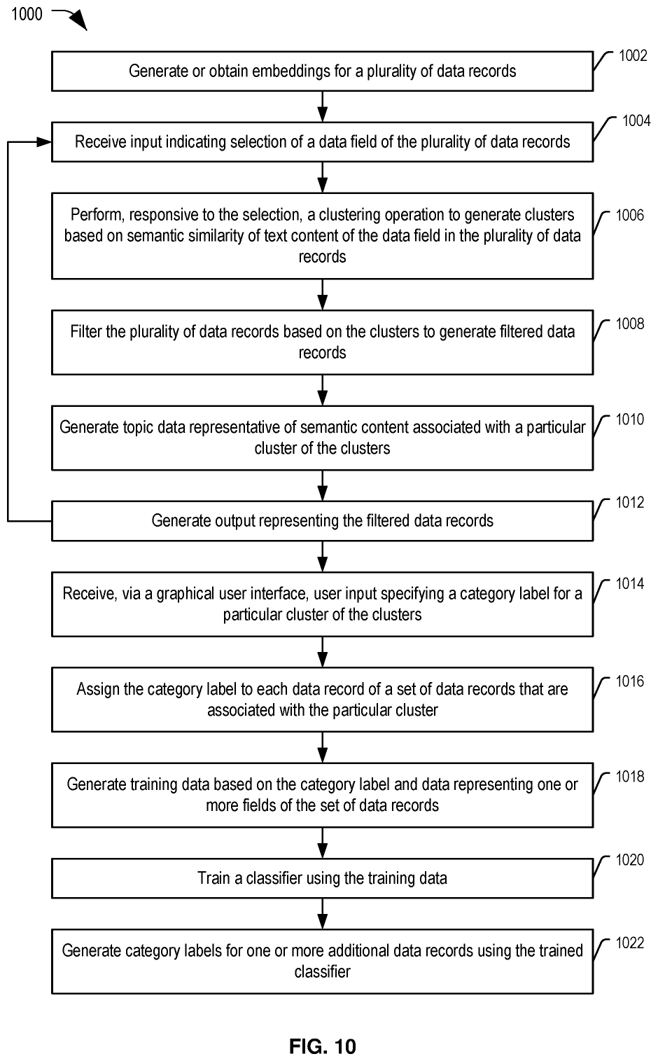

FIG. 10 is a flow chart of another example of a method 1000 of ad hoc analysis of data records that include textual content. The method 1000 may be performed by a computing device, such as the record analysis system 114 of FIG. 1, the device 202 of FIG. 2, a computing system 1200 of FIG. 12, or by a combination of any of the systems described herein.

The method 1000 includes, at 1002, generating or obtaining embeddings for a plurality of data records. For example, the embedding generator 220 may generate the embeddings 222 based on text stored in data fields 211 of the data records 112. In other examples, the embeddings 222 may be generated by a system distinct from the record analysis system 114, such as by a component of the record management system 102 of FIG. 1 and stored with the data records 112 in the repository 104. In such examples, the embeddings 222 may be obtained by reading them from the repository 104. Each embedding can represent a subset of the text content of one data field in one particular data record (e.g., a phrase, clause, or sentence), the entire text content of the data field in one particular data record, or the text content of two or more data fields of the one particular data record.

The method 1000 also includes, at 1004, receiving input indicating selection of a data field of a plurality of data records. For example, the record analysis system 114 of FIG. 1 or 2 may receive user input 126 selecting a particular data field (e.g., one or more of data field(s) 211 of FIG. 2). In this example, the particular data field is one of a group of data fields of the data records 112. In a particular aspect, the data fields of the data records 112 include at least one data field that stores text (e.g., natural language and/or unstructured text), and the data field selected from among the plurality of records includes or corresponds to one of the data fields that stores text. The data field of each of the plurality of data records may be represented by a respective one of the embeddings 222.

The method 1000 further includes, at 1006, responsive to the selection, performing a clustering operation to generate clusters based on semantic similarity of text content of the data field in the plurality of data records. For example, the ad hoc clustering engine 116 of FIG. 1 or 2 may generate the clusters based on embeddings representing the text content of the data field for each data record 112. In particular implementations, the clustering operations include density-based clustering operations based on the embeddings. For example, each embedding can be treated as a point in an embedding space and proximity of two embeddings in the embedding space indicates semantic similarity of the text represented by the two embeddings. In this example, each cluster represents a region of high concentration of embeddings in the embedding space.

The method 1000 also includes, at 1008, filtering the plurality of data records based on the clusters to generate filtered data records. For example, the cluster generator 224 or the output generator 120 can filter the data records based on results of the clustering operations. In some implementations, each cluster includes two or more data records. In such implementations, some of the data records may not be assigned to a cluster. For example, if the embedding selected for clustering for a particular data record is not sufficiently close (in embedding space) to embeddings for any identified cluster, then the particular data record is not assigned to any cluster.

In the particular example illustrated in FIG. 10, the method 1000 further includes, at 1010, generating topic data representative of semantic content associated with a particular cluster of the clusters. For example, the record analysis system 114 may include a machine-learning based topic model, such as a latent semantic analysis algorithm, that is configured to generate the topic data for each of the clusters. For example, the topic data may include one or more topic words that are selected, by the topic model, from text content of the data field of the two or more data records that are assigned to the same cluster.

The method 1000 also includes, at 1012, generating output representing the filtered data records. To illustrate, a user can select a particular cluster in the GUI 700 to filter information presented in the results section 506 of the GUI 700 to information derived from the data records of the selected cluster. In implementations that include generating the topic data, the output may also include the topic data associated with each cluster.

In some implementations, the output representing the filtered data records may include user selectable control elements, such as check boxes, text fields, buttons, etc. In such implementations, the clusters may be modified or other clusters generated based on user input received via the user selectable control elements. For example, after the clusters are generated (at 1006), the method may include receiving user input selecting two or more clusters that are to be merged. In this example, the method may also include, merging the two or more clusters based on the user input to generate second clusters, filtering the plurality of data records based on the second clusters to generate second filtered data records, and generating output representing the second filtered data records.

In some implementations, the method 1000 includes more than one iteration of receiving input (e.g., at 1004), performing clustering operations (e.g., at 1006), filtering data records based on the clusters (e.g., at 1008), optionally generating topic data (e.g., at 1010), and generating output (e.g., at 1012). For example, after clustering operations are performed based on user input selecting a first data field (e.g., at block 1006), a user may provide second input indicating selection of at least one additional data field of the data records. In this example, responsive to the selection of the at least one additional data field, second clustering operations may be performed to generate clusters based on semantic similarity of text content of the at least one additional data field in the filtered data records and second output may be generated based on the second clustering operation.

The method 1000 further includes, at 1014, receiving user input specifying the category label via a graphical user interface. For example, after performing the clustering operations (e.g., during one or more passes through block 1006), the user may assign a user-defined category label to one or more of the clusters. The GUI 700 of FIG. 7 is one example of a graphical user interface that is configured to receive such user-defined category labels.

The method 1000 also includes, at 1016, assigning a category label to each data record of a set of data records that are associated with a particular cluster of the clusters. For example, the record labeler 228 of FIG. 2 generates the labeled record data 230 based on the category labels assigned by the user 106 and based on the data records 112. To illustrate, in response to receiving the user input 126 indicating a category label associated with a particular cluster of the cluster data 226, the record labeler 228 determines which data records 112A are associated with the particular cluster and assigns the category label to each for the data records 112A associated with the particular cluster.

The method 1000 further includes, at 1018, generating training data based on the category label and data representing one or more fields of the set of data records, and at 1020, training a classifier using the training data. For example, the classifier trainer 232 of FIG. 2 is configured to train the record classifier 118. In some implementations, the classifier trainer 232 uses the labeled data records 230 as training data to train the record classifier 118. In other implementations, the classifier trainer 232 generates the training data based on the labeled data records 230.

The method 1000 further includes, at 1022, generating category labels for one or more additional data records using the trained classifier. For example, the record classifier 118 of FIGS. 1 and 2 is configured to assign category labels to data records (e.g., data records 112B) that are not specifically labeled in the labeled data records 230. For example, the data records 112B may include data records from the repository that the user 106 did not specifically label. As another example, the data records 112B may include new data records, e.g., data records added to the repository 104 after the clusters data 226 was generated.

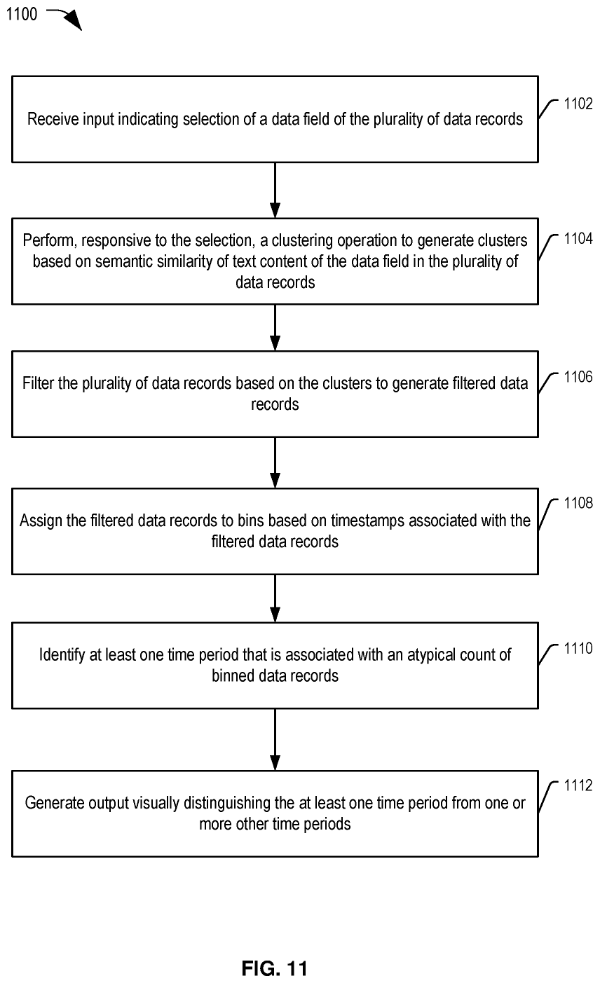

FIG. 11 is a flow chart of another example of a method 1100 of ad hoc analysis of data records that include textual content. The method 1100 may be performed by a computing device, such as the record analysis system 114 of FIG. 1, the device 202 of FIG. 2, a computing system 1200 of FIG. 12, or by a combination of any of the systems described herein.

The method 1100 includes, at 1102, receiving input indicating selection of a data field of a plurality of data records. For example, the record analysis system 114 of FIG. 1 or 2 may receive user input 126 selecting a particular data field (e.g., one or more of data field(s) 211 of FIG. 2). In this example, the particular data field is one of a group of data fields of the data records 112. In a particular aspect, the data fields of the data records 112 include at least one data field that stores text (e.g., natural language and/or unstructured text), and the data field selected from among the plurality of records includes or corresponds to one of the data fields that stores text.

The method 1100 also includes, at 1104, responsive to the selection, performing a clustering operation to generate clusters based on semantic similarity of text content of the data field in the plurality of data records. For example, the ad hoc clustering engine 116 of FIG. 1 or 2 may generate the clusters based on embeddings representing the text content of the data field for each data record 112. As explained above, the embeddings can be treated as points in an embedding space, and proximity of two embeddings in the embedding space indicates semantic similarity of the text represented by the two embeddings. Each embedding can represent a subset of the text content of the data field in the particular data record (e.g., a phrase, clause, or sentence), the entire text content of the data field in the particular data record, or the text content of two or more data fields in the data record. In particular implementations, the clustering operations include density-based clustering operations, such that each cluster represents a region of high concentration of embeddings in the embedding space.

The method 1100 further includes, at 1106, filtering the plurality of data records based on the clusters to generate filtered data records. For example, the cluster generator 224 or the output generator 120 can filter the data records based on results of the clustering operations to identify a subset of the data records 112 (e.g., the filtered data records).

The method 1100 also includes, at 1108, assigning the filtered data records to bins based on timestamps associated with the filtered data records. For example, as described with reference to FIG. 8, the filtered data records may be assigned to bins based on timestamps associated with the data records and based on binning criteria indicating, for example, a time period to be associated with each bin.

The method 1100 further includes, at 1110, identifying at least one time period that is associated with an atypical count of binned data records. In a particular implementation, the atypical count of binned data records is a count of binned data records that deviates from a moving average count of data records by more than a threshold amount. For example, the atypical count of binned data records may include a count of binned data records that is greater than the moving average count of data records by more than a threshold amount, such as is illustrated by period 688 of FIG. 8. As another example, the atypical count of binned data records may include a count of binned data records that is less than the moving average count of data records by more than a threshold amount, such as is illustrated by period 686 of FIG. 8. The threshold(s) may be determined based on variance of the count of binned data records during various time periods.

The method 1100 also includes, at 1112, generating output visually distinguishing the at least one time period from one or more other time periods. For example, as illustrated in FIG. 8, time periods that have an atypically high count of binned data records (such as period 688 of FIG. 8) may be visually distinguished from other binned data records in a time series section of a GUI, time periods that have an atypically low count of binned data records (such as period 686 of FIG. 8) may be visually distinguished from other binned data records in a time series section of a GUI, or both.

FIG. 12 is a block diagram of a particular computer system 1200 configured to initiate, perform, or control one or more of the operations described with reference to FIGS. 1-11. For example, the computer system 1200 may include, or be included within, the system 100 of FIG. 1 or the device 202 of FIG. 2. The computer system 1200 can be implemented as or incorporated into one or more of various other devices, such as a personal computer (PC), a tablet PC, a server computer, a distributed computing system, a personal digital assistant (PDA), a laptop computer, a desktop computer, a communications device, a wireless telephone, or any other machine or combination of machines capable of executing a set of instructions (sequential or otherwise) that specify actions to be taken by the machine(s). Further, while a single computer in system 1200 is illustrated, the term “system” includes any collection of systems or sub-systems that individually or jointly execute a set, or multiple sets, of instructions to perform one or more computer functions.

While FIG. 12 illustrates one example of the particular computer system 1200, other computer systems or computing architectures and configurations may be used for carrying out the automated model building operations disclosed herein. The computer system 1200 includes the one or more processors 204. Each processor of the one or more processors 204 can include a single processing core or multiple processing cores that operate sequentially, in parallel, or sequentially at times and in parallel at other times. Each processor of the one or more processors 204 includes circuitry defining a plurality of logic circuits 1202, working memory 1204 (e.g., registers and cache memory), communication circuits, etc., which together enable the processor to control the operations performed by the computer system 1200 and enable the processor to generate a useful result based on analysis of particular data and execution of specific instructions.

The processor(s) 204 are configured to interact with other components or subsystems of the computer system 1200 via a bus 1260. The bus 1260 is illustrative of any interconnection scheme serving to link the subsystems of the computer system 1200, external subsystems or devices, or any combination thereof. The bus 1260 includes a plurality of conductors to facilitate communication of electrical and/or electromagnetic signals between the components or subsystems of the computer system 1200. Additionally, the bus 1260 includes one or more bus controller or other circuits (e.g., transmitters and receivers) that manage signaling via the plurality of conductors and that cause signals sent via the plurality of conductors to conform to particular communication protocols.

The computer system 1200 also includes the one or more memory devices 206. The memory device(s) 206 include any suitable computer-readable storage device depending on, for example, whether data access needs to be bi-directional or unidirectional, speed of data access required, memory capacity required, other factors related to data access, or any combination thereof. Generally, the memory device(s) 206 include some combinations of volatile memory devices and non-volatile memory devices, though in some implementations, only one or the other may be present. Examples of volatile memory devices and circuits include registers, caches, latches, many types of random-access memory (RAM), such as dynamic random-access memory (DRAM), etc. Examples of non-volatile memory devices and circuits include hard disks, optical disks, flash memory, and certain types of RAM, such as resistive random-access memory (ReRAM). Other examples of both volatile and non-volatile memory devices can be used as well, or in the alternative, so long as such memory devices store information in a physical, tangible medium. Thus, the memory device(s) 206 include circuits and structures and are not merely signals or other transitory phenomena.

The memory device(s) 206 store the instructions 208 that are executable by the processor(s) 204 to perform various operations and functions. The instructions 208 include instructions to enable the various components and subsystems of the computer system 1200 to operate, interact with one another, and interact with a user, such as an input/output system (BIOS) 1214 and an operating system (OS) 1216. Additionally, the instructions 208 include one or more applications 1218, scripts, or other program code to enable the processor(s) 204 to perform the operations described herein. For example, the instructions 208 can include the record analysis system 114 of FIGS. 1 and 2.

In FIG. 12, the computer system 1200 also includes one or more network interfaces 1210, one or more input devices 1220, and the one or more interface devices 124. Each of the network interface(s) 1210, the input device(s) 1220, and the interface device(s) 124 can be coupled to the bus 1260 via a port or connector, such as a Universal Serial Bus port, a digital visual interface (DVI) port, a serial ATA (SATA) port, a small computer system interface (SCSI) port, a high-definition media interface (HMDI) port, or another serial or parallel port. In some implementations, one or more of the network interface(s) 1210, the input device(s) 1220, or the interface device(s) 124 are coupled to or integrated within a housing with the processor(s) 204 and the memory device(s) 206, in which case the connections to the bus 1260 can be internal, such as via an expansion slot or other card-to-card connector. In other implementations, the processor(s) 204 and the memory device(s) 206 are integrated within a housing that includes one or more external ports, and the network interface(s) 1210, the input device(s) 1220, and/or the interface device(s) 124 are coupled to the bus 1260 via the external port(s).

Examples of the interface device(s) 124 include display devices, speakers, printers, televisions, projectors, or other devices to provide output of data in a manner that is perceptible by a user, such as via the output generate 120 of FIGS. 1 and 2. Examples of the input device(s) 1220 include buttons, switches, knobs, a keyboard 1222, a pointing device 1224, a biometric device, a microphone, a motion sensor, or another device to detect user input actions. In a particular implementation, the interface device(s) 124 include a display device to display one or more user interfaces 1250. The user interface(s) 1250 may include, for example, any one or more of GUIs 500. 600. 700. 800 of FIGS. 5-8, or any other similar GUIs. The pointing device 1224 includes, for example, one or more of a mouse, a stylus, a track ball, a pen, a touch pad, a touch screen, a tablet, another device that is useful for interacting with a graphical user interface, or any combination thereof.

The network interface(s) 1210 are configured to enable the computer system 1200 to communicate with one or more other computer systems 1244 via one or more networks 1242. The interface device(s) 1206 encode data in electrical and/or electromagnetic signals that are transmitted to the other computer system(s) 1244 using pre-defined communication protocols. The electrical and/or electromagnetic signals can be transmitted wirelessly (e.g., via propagation through free space), via one or more wires, cables, optical fibers, or via a combination of wired and wireless transmission.

The systems and methods illustrated herein may be described in terms of functional block components, screen shots, optional selections, and various processing steps. It should be appreciated that such functional blocks may be realized by any number of hardware and/or software components configured to perform the specified functions. For example, a system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C #, Java, JavaScript, VBScript, Macromedia Cold Fusion, COBOL, Microsoft Active Server Pages, assembly, PERL, PHP, AWK, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of techniques for data transmission, signaling, data processing, network control, and the like.

The systems and methods of the present disclosure may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet based (e.g., cloud computing) embodiment, an entirely hardware embodiment, or an embodiment combining aspects of the internet, software, and hardware. Furthermore, the system may take the form of a computer program product on a computer-readable storage medium or device having computer-readable program code (e.g., instructions) embodied or stored in the storage medium or device. Any suitable computer-readable storage medium or device may be utilized, including hard disks, CD-ROM, optical storage devices, magnetic storage devices, and/or other storage media. A computer-readable storage medium or device is not a signal.

Systems and methods may be described herein with reference to screen shots, block diagrams and flowchart illustrations of methods, apparatuses (e.g., systems), and computer media according to various aspects. It will be understood that each functional block of a block diagrams and flowchart illustration, and combinations of functional blocks in block diagrams and flowchart illustrations, respectively, can be implemented by computer program instructions.

Computer program instructions may be loaded onto a computer or other programmable data processing apparatus to produce a machine, such that the instructions that execute on the computer or other programmable data processing apparatus create means for implementing the functions specified in the flowchart block or blocks. These computer program instructions may also be stored in a computer-readable memory or device that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

Methods disclose herein may be embodied as computer program instructions on a tangible computer-readable medium, such as a magnetic or optical memory or a magnetic or optical disk/disc. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Particular aspects of the disclosure are described below in a first set of interrelated

### EXAMPLES

According to Example 1 a device includes: one or more memory devices storing instructions; and one or more processors configured to execute the instructions to: receive input indicating selection of a data field of a plurality of data records; responsive to the selection, perform a clustering operation to generate clusters based on semantic similarity of text content of the data field in the plurality of data records; filter the plurality of data records based on the clusters to generate filtered data records; and generate output representing the filtered data records.

Example 2 includes the device of Example 1, wherein the one or more processors are further configured to: assign a category label to each data record of a set of data records that are associated with a particular cluster of the clusters; generate training data based on the category label and data representing one or more fields of the set of data records; and train a classifier using the training data.

Example 3 includes the device of Example 2, wherein the one or more processors are further configured to generate category labels for one or more additional data records using the trained classifier.

Example 4 includes the device of Example 2, wherein the one or more processors are further configured to receive user input specifying the category label via a graphical user interface.

Example 5 includes the device of Example 1, wherein the one or more processors are further configured to, after performing the clustering operation, generate topic data representative of semantic content associated with a particular cluster of the clusters, wherein the output includes a graphical user interface depicting the topic data.

Example 6 includes the device of Example 1, wherein the one or more processors are further configured to generate embeddings for the plurality of data records, an embedding for a particular data record representing at least a portion of the text content of the data field in the particular data record, wherein the clustering operation is based on the embeddings.

Example 7 includes the device of Example 6, wherein the embedding for the particular data record represents a subset of the text content of the data field in the particular data record.

Example 8 includes the device of Example 6, wherein the embedding for the particular data record represents an entirety of the text content of the data field in the particular data record.

Example 9 includes the device of Example 6, wherein the embedding for the particular data record represents the text content of the data field in the particular data record and content of at least one additional data field of the particular data record.

Example 10 includes the device of Example 1, wherein the clustering operation uses density-based clustering.

Example 11 includes the device of Example 1, wherein the input further indicates selection of at least one additional data field, and wherein the clustering operation is further based on semantic similarity of text content of the at least one additional data field in the plurality of data records.

Example 12 includes the device of Example 1, wherein the one or more processors are further configured to, after generating the output representing the filtered data records: receive second input indicating selection of at least one additional data field; responsive to the selection of the at least one additional data field, perform a second clustering operation to generate clusters based on semantic similarity of text content of the at least one additional data field in the filtered data records; and generate second output based on the second clustering operation.

Example 13 includes the device of Example 1, wherein the one or more processors are further configured to, after performing the clustering operation: receive user input selecting two or more clusters; merge the two or more clusters based on the user input to generate second clusters; filter the plurality of data records based on the second clusters to generate second filtered data records; and generate output representing the second filtered data records.

Example 14 includes the device of Example 1, wherein the output indicates that two or more data records of the plurality of data records are associated with a particular cluster.

Example 15 includes the device of Example 14, wherein the output further indicates one or more topic words that are associated with the particular cluster, wherein the one or more topic words are selected from text content of the data field of the two or more data records.

Example 16 includes the device of Example 1, wherein the one or more processors are further configured to: assign the filtered data records to bins based on timestamps associated with the filtered data records; and identify at least one time period that is associated with an atypical count of binned data records, wherein the output visually distinguishes the at least one time period from one or more other time periods.

Example 17 includes the device of Example 16, wherein identifying at least one time period that is associated with the atypical count of binned data records includes: determining, based on the binned data records, a moving average count of data records for a first time window length; and performing a sliding window comparison of a count of binned data records during each period of the first time window length to the moving average count of data records, wherein a particular period is identified as associated with an atypical count of binned data records when the count of binned data records during the particular period deviates from the moving average count of data records by more than a threshold.

According to Example 18 a method includes: receiving, at one or more processors, input indicating selection of a data field of a plurality of data records; responsive to the selection, performing, by the one or more processors, a clustering operation to generate clusters based on semantic similarity of text content of the data field in the plurality of data records; filtering, by the one or more processors, the plurality of data records based on the clusters to generate filtered data records; and generating output representing the filtered data records.

Example 19 includes the method of Example 18, further including: assigning a category label to each data record of a set of data records that are associated with a particular cluster of the clusters; generating training data based on the category label and data representing one or more fields of the set of data records; and training a classifier using the training data.

Example 20 includes the method of Example 19, further including generating category labels for one or more additional data records using the trained classifier.

Example 21 includes the method of Example 19, further including receiving user input specifying the category label via a graphical user interface.

Example 22 includes the method of Example 18, further including, after performing the clustering operation, generating, by the one or more processors, topic data representative of semantic content associated with a particular cluster of the clusters, wherein the output includes a graphical user interface depicting the topic data.

Example 23 includes the method of Example 18, further including generating

embeddings for the plurality of data records, an embedding for a particular data record representing at least a portion of the text content of the data field in the particular data record, wherein the clustering operation is based on the embeddings.

Example 24 includes the method of Example 23, wherein the embedding for the particular data record represents a subset of the text content of the data field in the particular data record.

Example 25 includes the method of Example 23, wherein the embedding for the particular data record represents an entirety of the text content of the data field in the particular data record.

Example 26 includes the method of Example 23, wherein the embedding for the particular data record represents the text content of the data field in the particular data record and content of at least one additional data field of the particular data record.

Example 27 includes the method of Example 18, wherein the clustering operation uses density-based clustering.

Example 28 includes the method of Example 18, wherein the input further indicates selection of at least one additional data field, and wherein the clustering operation is further based on semantic similarity of text content of the at least one additional data field in the plurality of data records.

Example 29 includes the method of Example 18, further including, after generating the output representing the filtered data records: receiving second input indicating selection of at least one additional data field; responsive to the selection of the at least one additional data field, performing a second clustering operation to generate clusters based on semantic similarity of text content of the at least one additional data field in the filtered data records; and generating second output based on the second clustering operation.

Example 30 includes the method of Example 18, further including, after performing the clustering operation: receiving user input selecting two or more clusters; merging the two or more clusters based on the user input to generate second clusters; filtering the plurality of data records based on the second clusters to generate second filtered data records; and generating output representing the second filtered data records.

Example 31 includes the method of Example 18, wherein the output indicates that two or more data records of the plurality of data records are associated with a particular cluster.

Example 32 includes the method of Example 31, wherein the output further indicates one or more topic words that are associated with the particular cluster, wherein the one or more topic words are selected from text content of the data field of the two or more data records.

Example 33 includes the method of Example 18, further including: assigning the filtered data records to bins based on timestamps associated with the filtered data records; and identifying at least one time period that is associated with an atypical count of binned data records, wherein the output visually distinguishes the at least one time period from one or more other time periods.

Example 34 includes the method of Example 33, wherein identifying at least one time period that is associated with the atypical count of binned data records includes: determining, based on the binned data records, a moving average count of data records for a first time window length; and performing a sliding window comparison of a count of binned data records during each period of the first time window length to the moving average count of data records, wherein a particular period is identified as associated with an atypical count of binned data records when the count of binned data records during the particular period deviates from the moving average count of data records by more than a threshold.

According to Example 35 a computer-readable storage device stores instructions that are executable by one or more processors to cause the one or more processors to perform operations including: receiving input indicating selection of a data field of a plurality of data records; responsive to the selection, performing a clustering operation to generate clusters based on semantic similarity of text content of the data field in the plurality of data records; filtering the plurality of data records based on the clusters to generate filtered data records; and generating output representing the filtered data records.

Example 36 includes the computer-readable storage device of Example 35, wherein the operations further include: assigning a category label to each data record of a set of data records that are associated with a particular cluster of the clusters; generating training data based on the category label and data representing one or more fields of the set of data records; and training a classifier using the training data.

Example 37 includes the computer-readable storage device of Example 36, wherein the operations further include generating category labels for one or more additional data records using the trained classifier.

Example 38 includes the computer-readable storage device of Example 36, wherein the operations further include receiving user input specifying the category label via a graphical user interface.

Example 39 includes the computer-readable storage device of Example 35, wherein the operations further include, after performing the clustering operation, generating topic data representative of semantic content associated with a particular cluster of the clusters, wherein the output includes a graphical user interface depicting the topic data.

Example 40 includes the computer-readable storage device of Example 35, wherein the operations further include generating embeddings for the plurality of data records, an embedding for a particular data record representing at least a portion of the text content of the data field in the particular data record, wherein the clustering operation is based on the embeddings.

Example 41 includes the computer-readable storage device of Example 40, wherein the embedding for the particular data record represents a subset of the text content of the data field in the particular data record.

Example 42 includes the computer-readable storage device of Example 40, wherein the embedding for the particular data record represents an entirety of the text content of the data field in the particular data record.

Example 43 includes the computer-readable storage device of Example 40, wherein the embedding for the particular data record represents the text content of the data field in the particular data record and content of at least one additional data field of the particular data record.

Example 44 includes the computer-readable storage device of Example 35, wherein the clustering operation uses density-based clustering.

Example 45 includes the computer-readable storage device of Example 35, wherein the input further indicates selection of at least one additional data field, and wherein the clustering operation is further based on semantic similarity of text content of the at least one additional data field in the plurality of data records.

Example 46 includes the computer-readable storage device of Example 35, wherein the operations further include, after generating the output representing the filtered data records: receiving second input indicating selection of at least one additional data field; responsive to the selection of the at least one additional data field, performing a second clustering operation to generate clusters based on semantic similarity of text content of the at least one additional data field in the filtered data records; and generating second output based on the second clustering operation.

Example 47 includes the computer-readable storage device of Example 35, wherein the operations further include, after performing the clustering operation: receiving user input selecting two or more clusters; merging the two or more clusters based on the user input to generate second clusters; filtering the plurality of data records based on the second clusters to generate second filtered data records; and generating output representing the second filtered data records.

Example 48 includes the computer-readable storage device of Example 35, wherein the output indicates that two or more data records of the plurality of data records are associated with a particular cluster.

Example 49 includes the computer-readable storage device of Example 48, wherein the output further indicates one or more topic words that are associated with the particular cluster, wherein the one or more topic words are selected from text content of the data field of the two or more data records.

Example 50 includes the computer-readable storage device of Example 35, wherein the operations further include: assigning the filtered data records to bins based on timestamps associated with the filtered data records; and identifying at least one time period that is associated with an atypical count of binned data records, wherein the output visually distinguishes the at least one time period from one or more other time periods.

Example 51 includes the computer-readable storage device of Example 50, wherein identifying at least one time period that is associated with the atypical count of binned data records includes: determining, based on the binned data records, a moving average count of data records for a first time window length; and performing a sliding window comparison of a count of binned data records during each period of the first time window length to the moving average count of data records, wherein a particular period is identified as associated with an atypical count of binned data records when the count of binned data records during the particular period deviates from the moving average count of data records by more than a threshold.

Changes and modifications may be made to the disclosed embodiments without departing from the scope of the present disclosure. These and other changes or modifications are intended to be included within the scope of the present disclosure, as expressed in the following claims.

What is claimed is:

1. A device comprising:
one or more memory devices storing instructions; and
one or more processors configured to execute the instructions to:
receive input indicating selection of a data field of a plurality of data records;
responsive to the selection, perform a clustering operation to generate clusters based on semantic similarity of text content of the data field in the plurality of data records;
filter the plurality of data records based on the clusters to generate filtered data records; and
generate output representing the filtered data records.

2. The device of claim 1, wherein the one or more processors are further configured to:
assign a category label to each data record of a set of data records that are associated with a particular cluster of the clusters;
generate training data based on the category label and data representing one or more fields of the set of data records; and
train a classifier using the training data.

3. The device of claim 2, wherein the one or more processors are further configured to generate category labels for one or more additional data records using the trained classifier.

4. The device of claim 2, wherein the one or more processors are further configured to receive user input specifying the category label via a graphical user interface.

5. The device of claim 1, wherein the one or more processors are further configured to, after performing the clustering operation, generate topic data representative of semantic content associated with a particular cluster of the clusters, wherein the output includes a graphical user interface depicting the topic data.

6. The device of claim 1, wherein the one or more processors are further configured to generate embeddings for the plurality of data records, an embedding for a particular data record representing at least a portion of the text content of the data field in the particular data record, wherein the clustering operation is based on the embeddings.

7. The device of claim 6, wherein the embedding for the particular data record represents a subset of the text content of the data field in the particular data record.

8. The device of claim 6, wherein the embedding for the particular data record represents an entirety of the text content of the data field in the particular data record.

9. The device of claim 6, wherein the embedding for the particular data record represents the text content of the data field in the particular data record and content of at least one additional data field of the particular data record.

10. A method comprising:
receiving, at one or more processors, input indicating selection of a data field of a plurality of data records;
responsive to the selection, performing, by the one or more processors, a clustering operation to generate clusters based on semantic similarity of text content of the data field in the plurality of data records;
filtering, by the one or more processors, the plurality of data records based on the clusters to generate filtered data records; and
generating output representing the filtered data records.

11. The method of claim 10, wherein the clustering operation uses density-based clustering.

12. The method of claim 10, wherein the input further indicates selection of at least one additional data field, and wherein the clustering operation is further based on semantic similarity of text content of the at least one additional data field in the plurality of data records.

13. The method of claim 10, further comprising, after generating the output representing the filtered data records:
receiving second input indicating selection of at least one additional data field;
responsive to the selection of the at least one additional data field, performing a second clustering operation to generate clusters based on semantic similarity of text content of the at least one additional data field in the filtered data records; and
generating second output based on the second clustering operation.

14. The method of claim 10, further comprising, after performing the clustering operation:
receiving user input selecting two or more clusters;
merging the two or more clusters based on the user input to generate second clusters;
filtering the plurality of data records based on the second clusters to generate second filtered data records; and
generating output representing the second filtered data records.

15. The method of claim 10, wherein the output indicates that two or more data records of the plurality of data records are associated with a particular cluster.

16. The method of claim 15, wherein the output further indicates one or more topic words that are associated with the particular cluster, wherein the one or more topic words are selected from text content of the data field of the two or more data records.

17. The method of claim 10, further comprising:
assigning the filtered data records to bins based on timestamps associated with the filtered data records; and
identifying at least one time period that is associated with an atypical count of binned data records, wherein the output visually distinguishes the at least one time period from one or more other time periods.

18. The method of claim 10, wherein identifying at least one time period that is associated with the atypical count of binned data records includes:
determining, based on the binned data records, a moving average count of data records for a first time window length; and
performing a sliding window comparison of a count of binned data records during each period of the first time window length to the moving average count of data records, wherein a particular period is identified as associated with an atypical count of binned data records when the count of binned data records during the particular period deviates from the moving average count of data records by more than a threshold.

19. A computer-readable storage device storing instructions that are executable by one or more processors to cause the one or more processors to perform operations comprising:
receiving input indicating selection of a data field of a plurality of data records;
responsive to the selection, performing a clustering operation to generate clusters based on semantic similarity of text content of the data field in the plurality of data records;
filtering the plurality of data records based on the clusters to generate filtered data records; and
generating output representing the filtered data records.

20. The computer-readable storage device of claim 19, wherein the operations further comprise:
assigning a category label to each data record of a set of data records that are associated with a particular cluster of the clusters;
generating training data based on the category label and data representing one or more fields of the set of data records; and
training a classifier using the training data.
